(19) United States
(12) Patent Application Publication
(10) Pub. No.: US 2013/0232258 A1
(43) Pub. Date: Sep. 5, 2013

(54) SYSTEMS AND METHODS FOR DIAGNOSTIC, PERFORMANCE AND FAULT MANAGEMENT OF A NETWORK

(71) Applicant: NEUTRAL TANDEM, INC. D/B/A INTELIQUENT, Chicago, IL (US)

(72) Inventors: John Bullock, Oak Park, IL (US); Imad Al Ajarmeh, Hickory HIlls, IL (US); Yenming Cheng, Naperville, IL (US); Jenwei Lai, Chicago, IL (US)

(73) Assignee: NEUTRAL TANDEM, INC. D/B/A INTELIQUENT, Chicago, IL (US)

(21) Appl. No.: 13/783,163

(22) Filed: Mar. 1, 2013

Related U.S. Application Data
(60) Provisional application No. 61/606,229, filed on Mar. 2, 2012.

(51) Int. Cl. H04L 12/26

(52) U.S. Cl. CPC H04L 43/045
USPC 709/224

(57) ABSTRACT

A system for analyzing, monitoring and detecting fault and performance across a network comprised of one or more networks of external elements, wherein the networks may be under different administrations. Among other things, the system permits users to monitor the connectivity status of the different links of the network; provides users event and system performance information; permits users to isolate certain portions of the network and review system performance data and events related to those isolated portions of the network; and permits such fault management across multiple connected networks, portions of which may be owned by different parties.

### PRIORITY CLAIM

This is a non-provisional application claiming priority to, and the benefit of, U.S. Provisional Patent Application No. 61/606,229, filed on Mar. 2, 2012, the entire contents of which is incorporated by reference herein.

### TECHNICAL FIELD

This disclosure relates to the field of telecommunications, and more particularly to diagnostics, performance and fault management of a network comprised of multiple networks, such as a central network and multiple provider networks, which may comprise, for example, one or more Ethernet networks.

### BACKGROUND

The fact that networks connect multiple systems through multiple interfaces results in a plurality of locations on any given network where a fault or performance impairment may occur. Such analysis, fault and performance management is further complicated when an overall network is comprised of a central network and multiple separately owned provider networks. The systems and methods described herein involve but are not limited to providing network analysis, real time fault and performance management information to analyze, monitor, detect and address such issues.

### SUMMARY

A system for analyzing, monitoring and detecting fault and performance across a network comprised of one or more networks of external elements is provided. The system permits users to monitor the connectivity status of the different links of the network. In another aspect of the system, event and system performance information is provided to a user, The system also permits users to isolate certain portions of the network and review system performance data and events related to those isolated portions of the network. The system permits such fault management across multiple connected networks, portions of which may be owned or administered by different parties. These and other aspects will become readily apparent from the written specification, drawings, and claims provided herein.

### BRIEF DESCRIPTION OF DRAWINGS

FIG. 1 is a schematic diagram illustrating an exemplary embodiment of a system in accordance with one or more aspects described herein.

FIG. 2 is a schematic diagram illustrating the connectivity of an exemplary embodiment of a system in accordance with one or more aspects described herein.

FIGS. 3A-3B are schematic diagrams illustrating exemplary edge location configurations according to one or more aspects described herein.

FIGS. 4A-4B are schematic diagrams illustrating exemplary edge location configurations according to one or more aspects described herein.

FIG. 5 is a schematic diagram of an exemplary network configuration in connection with application services for purposes of illustrating one or more aspects described herein.

FIGS. 6-42 are exemplary illustrations of screenshots associated with an exemplary embodiment of a portal in accordance with on or more aspects described herein.

### DETAILED DESCRIPTION OF EXEMPLARY EMBODIMENTS

The description that follows describes, illustrates and exemplifies one or more particular embodiments of the invention(s) in accordance with its principles. This description is not provided to limit the invention(s) to the embodiments described herein, but rather to explain and teach the principles of the invention(s) in such a way to enable one of ordinary skill in the art to understand these principles and, with that understanding, be able to apply them to practice not only the embodiments described herein, but also other embodiments that may come to mind in accordance with these principles. The scope of the invention(s) is/are intended to cover-all such embodiments that may fall within the scope of the claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the present specification is intended to be taken as a whole and interpreted in accordance with the principles of the invention(s) as taught herein and understood to one of ordinary skill in the art.

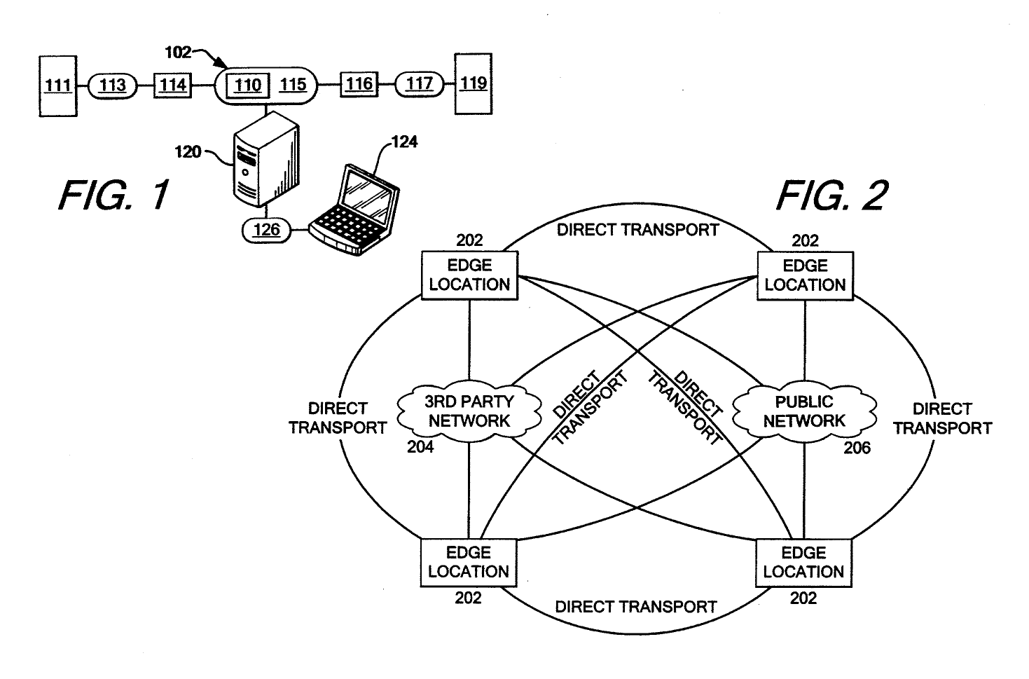

FIG. 1 is a schematic diagram illustrating an exemplary system framework 100 within which one or more principles of the invention(s) may be employed. At the outset, it should be understood that the invention may be embodied by, or employed in, numerous configurations and components, including one or more system, hardware, software, or firmware configurations or components, or any combination thereof, as understood by one of ordinary skill in the art. Furthermore, the invention(s) should not be construed as limited by the schematic illustrated in FIG. 1, nor any of the exemplary embodiments described herein.

System 100 includes an overall network 102, such as an Ethernet network. The overall network has a central network 115, sometimes referred to herein as the backbone. The central network 115 is communicatively connected to multiple separately owned and managed. networks, referred to herein as provider networks 113 and 117 via network to network interfaces or ports (ENNIs) 114 and 116 respectively. The provider networks 113 and 117 are connected to consumer end points 111 and 119. Provider networks 113 and 117 may themselves be comprised of subnetworks. As would be apparent to one of ordinary skill in the art, system 100 may include more than two provider networks.

Referring again to FIG. 1, a system, computer or server 120 provides a portal application associated with, or capable of communicating with, the central service network. The portal application provides the user with information regarding functionality, fault and performance management of the network. The user may access the portal via a client device 124, such as computer, over a network 126, such as the Internet. It should be noted that while a portal application operating on a server is described herein, other implementations to provide such functionality are possible and considered within the scope of this aspect. As will be described in more detail below, aspects of the systems and methods can be used for managing interconnection and service aspects amongst a plurality of external elements, such as the exemplary external elements described above. However, further description of the exemplary framework 100 and exemplary architecture will be helpful in understanding these aspects.

FIG. 2 illustrates exemplary connectivity and transport between edge locations 202 within a central service network, such as central service network 115. As shown in FIG. 2, connectivity between each of the edge locations 202 may be via direct transport to one or more of the other edge locations 202, or it may also involve connection through one or more networks such as a third-party network 204 or a public network 206, such as the Internet. Each of these edge locations 202 connects to and communicates with an external element, such as, for example, any of the elements described above. Thus, by way of example, the central service network facilitates connections, such as a data or telecommunications service connection, that a user may desire to a particular location outside the user's existing system or network.

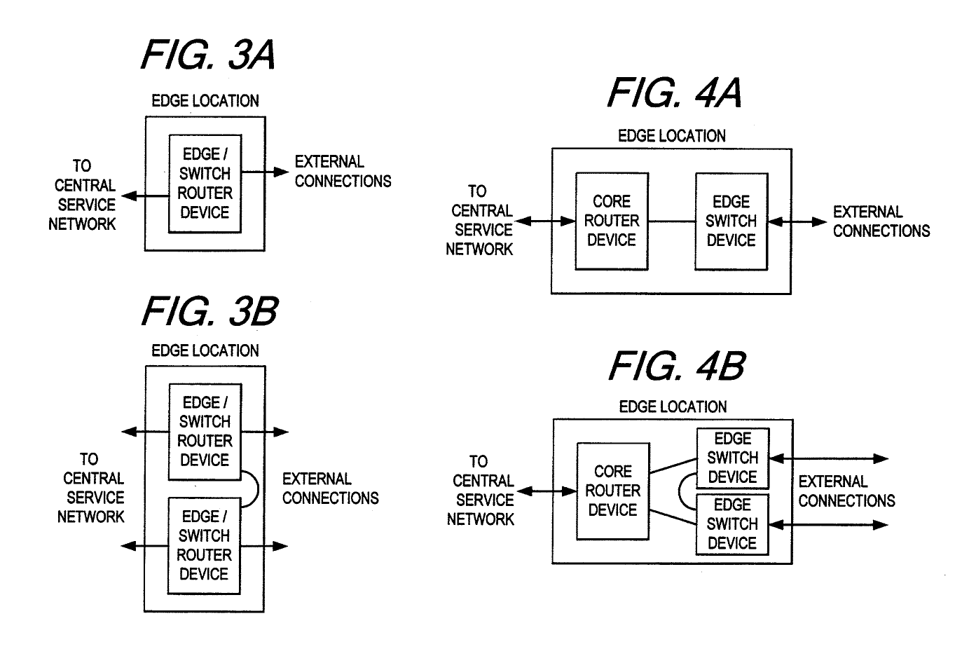

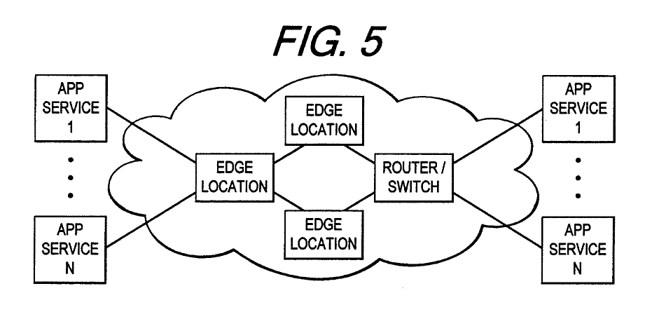

For further context of exemplary architecture with respect to the edge locations, FIGS. 3A, 3B, 4A and 4B illustrate various edge location configurations that may be employed to provide connectivity to external elements with the understanding that any number of configurations known in the art may be employed. As shown in FIG. 3A, an edge location may be configured as a single edge switch/router device, wherein the edge switch/router device is in communication with the central service network and is capable of or in communication with one or more external elements, thereby providing external connections for the benefit of the users of the central service network. As shown in FIG. 3B, an edge location may be configured with two or more edge switches/router devices primarily for redundancy. In this configuration, each edge switch/router device is in communication with the central service network and is capable of or in communication with one or more external elements. The edge switches/router devices are also in communication with each other. As shown in FIG. 4A, an edge location may be configured with a core router device separate from and in communication with an edge switch device. As shown in FIG. 4B, an edge location may be configured with a core router device separate from and in communication with two or more edge switch devices for redundancy. In a particular implementation, the central service network is an Ethernet network which employs one or more Ethernet switches, which is preferably a multi-port switch module or an array of modules. The Ethernet switch may be, merely by way of example, one or more components from the 6500 Catalyst Series from Cisco Systems, Inc., which may include one or more supervisors, chassis configurations, modules, PC cards, as well as operating system software.

As previously mentioned, the central service network may provide connectivity to any number of external elements, including a plurality of application services. Such connectivity may be employed in any number of ways as known in the art. As shown in FIG. 4, one or more application services may be accessible to a user via one or more edge location connections. Furthermore, one or more application services may be accessible within the central service network and connectable via a router/switch within the network. It is contemplated that one or more application services may be hosted by central service network for the benefit of network users.

As previously mentioned, according to a particular aspect, a system for identifying, analyzing and managing performance across the entire network, from end to end, is contemplated. The system includes the aforementioned network, which includes a plurality of edge connection points in communication with each other and each either in communication with or capable communicating with at least one of the plurality of external elements. Server 120, which is in communication with the central service network, hosts a portal application accessible to manage performance, analysis and fault identification amongst the various elements. The portal application has visibility of the edge connection points and connected external elements to determine manageability of interconnection and service aspects for one or more selected external elements. The same server or another server may also have stored thereon a database containing data related to the network and or user profile and settings information.

While depicted schematically as a single server, computer or system, it should be understood that the term “server” as used herein and as depicted schematically herein may represent more than one server or computer within a single system or across a plurality of systems, or other types of processor based computers or systems. The server 120 includes at least one processor, which is a hardware device for executing software/code, particularly software stored in a memory or stored in or carried by any other computer readable medium. The processor can be any custom made or commercially available processor, a central processing unit (CPU), an auxiliary processor among several processors associated with the server 120, a semiconductor based microprocessor (in the form of a microchip or chip set), another type of microprocessor, or generally any device for executing software code/instructions. The processor may also represent a distributed processing architecture.

The server operates with associated memory and can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, memory may incorporate electronic, magnetic, optical, and/or other types of storage media. Memory can have a distributed architecture where various components are situated remote from one another, but are still accessed by the processor.

The software in memory or any other computer readable medium may include one or more separate programs. The separate programs comprise ordered listings of executable instructions or code, which may include one or more code segments, for implementing logical functions. In the exemplary embodiments herein, a server application or other application runs on a suitable operating system (O/S). The operating system essentially controls the execution of the portal application, or any other computer programs of server 120, and provides scheduling, input-output control, file and data management, memory management, and communication control and related services.

Within the central network is an Ethernet switch 110 sometimes referred to herein as a central network router, which is preferably a multi-port switch module or an array of modules, provides connectivity, switching and related control between one or more of the plurality of provider networks 113 and 117. The switch 110 may be, merely by way of example, one or more components from the 6500 Catalyst Series from Cisco Systems, Inc., which may include one or more supervisors, chassis configurations, modules, PC cards, as well as operating system software. The Ethernet switch is typically associated with a connectivity service provider.

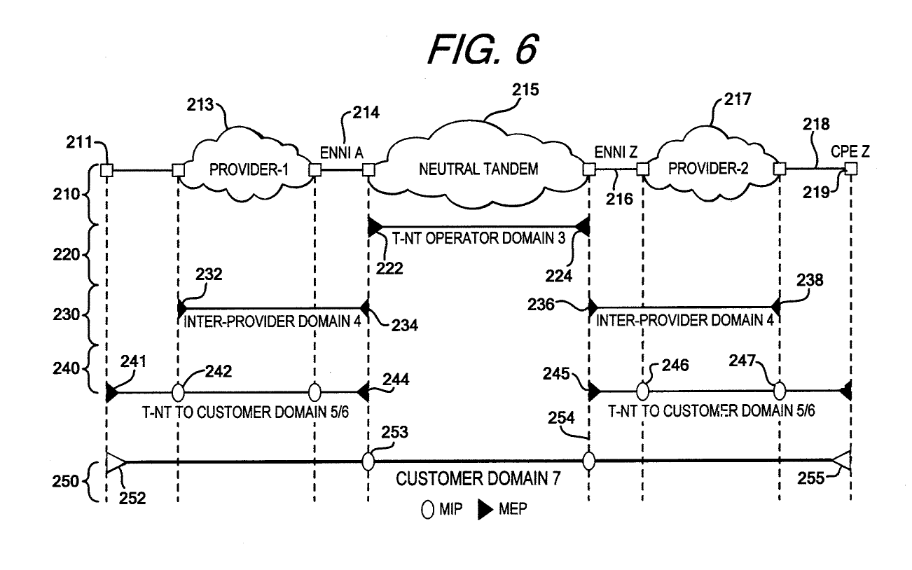

FIG. 6 is a schematic depiction of an exemplary network from a service operations and administration management perspective. A top level depiction of certain network elements is shown in level 210. As shown therein, one or more customer premises equipment (CPE) 211 is communicatively connected to a first provider network 213. The customer premises equipment may be any terminal and associated equipment located at the service provider customer's premises. The CPE may be connected via a demarcation point or demarcation device established in the premises to separate customer equipment from the equipment located in either the distribution infrastructure or central office of the communications service provider. The CPE may be comprised of devices such as, for example, and without limitation, routers, Network Interface Devices (NIDs), switches, residential gateways (RG), set-top boxes, fixed mobile convergence products, home networking adaptors, internet access gateways, or the like, that enable consumers to access the first service provider's network, which in some instances may be via a LAN (Local Area Network).

As shown in FIG. 6, a first provider network 213 is communicatively connected to the central network 215, via a first network to network interface 214. The central network 215 is connected to a second provider network 217 via a second network to network interface 216. The second provider network 217 is connected to a second CPE 219.

While only two provider networks 213 and 217 are depicted in FIG. 6, it will be apparent to one of skill in the art that multiple provider networks may be communicatively connected to the central network. Similarly, one of skill in the art will recognize that each provider network may be communicatively connected to multiple CPEs.

As shown in FIG. 6, fault and performance management occur at a plurality of levels or domains, shown in FIG. 6 as items 220, 230, 240 and 250. In an embodiment, such fault and performance management uses the Y.1731 or 802.1ag protocols, which are incorporated herein by reference. Other suitable protocols may be used as well. As shown in FIG. 6, domain level 3, shown as item 220, is used for monitoring the central network 215 having maintenance endpoints 222 and 224 at the interface of the central network 215 to the first and second network to network interfaces 215 and 216. Domain level 4, shown as item 230, is used to monitor the provider networks 213 and 217, having a first maintenance end point 232 at the interface of the first provider network 213 to the first CPE 211 on one end and a second maintenance end point 234 at the interface of the first network to network interface 214 to the central network 215. A third maintenance end point 236 is at the interface of the central network 215 to the second network to network interface 216 and a fourth maintenance end point 238 is at the interface of the second provider network 217 and the second CPE 219. Domain levels 5 and 6 are used to monitor the network between the CPEs 211 and 219 and the central network 215. This domain level has a first maintenance end point 241 at the first CPE 211 on one end and a second maintenance end point 244 between the first network to network interface 214 and the central network 215. This domain level also has a third maintenance end point 245 on one end between the central network 215 and the second network to network interface 216 and a fourth maintenance end point 248 on the other end at the second CPE 219. Domain levels 5 and 6 also have maintenance intermediate points 242, 243, 246 and 247, located at the ends of the first and second provider networks. Domain level 7 is used to monitor the entire network from the first CPE 211 to the second CPE 219, having a first maintenance end point at the first CPE 211 and a second maintenance end point at the second CPE 219. Domain level 7 also has maintenance intermediate points 253 and 254 at the ends of the central network. The domain levels described herein are exemplary and an alternative domain level scheme may be used. For example domain level 5 instead of domain level 3 may be used for core network and domain level 3 may be used for the edge network.

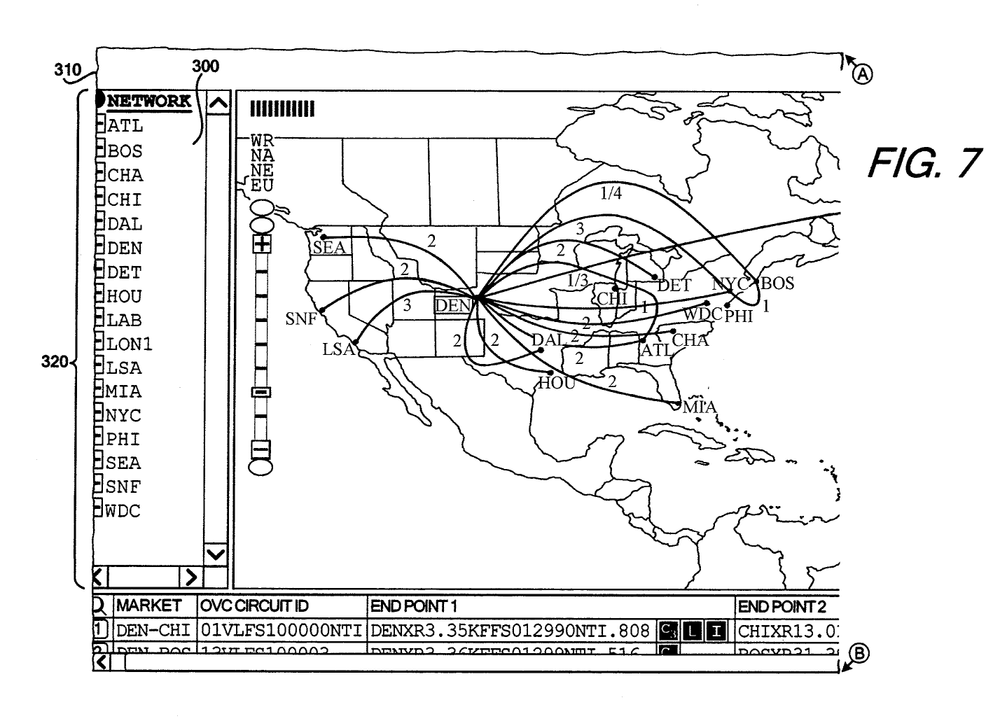

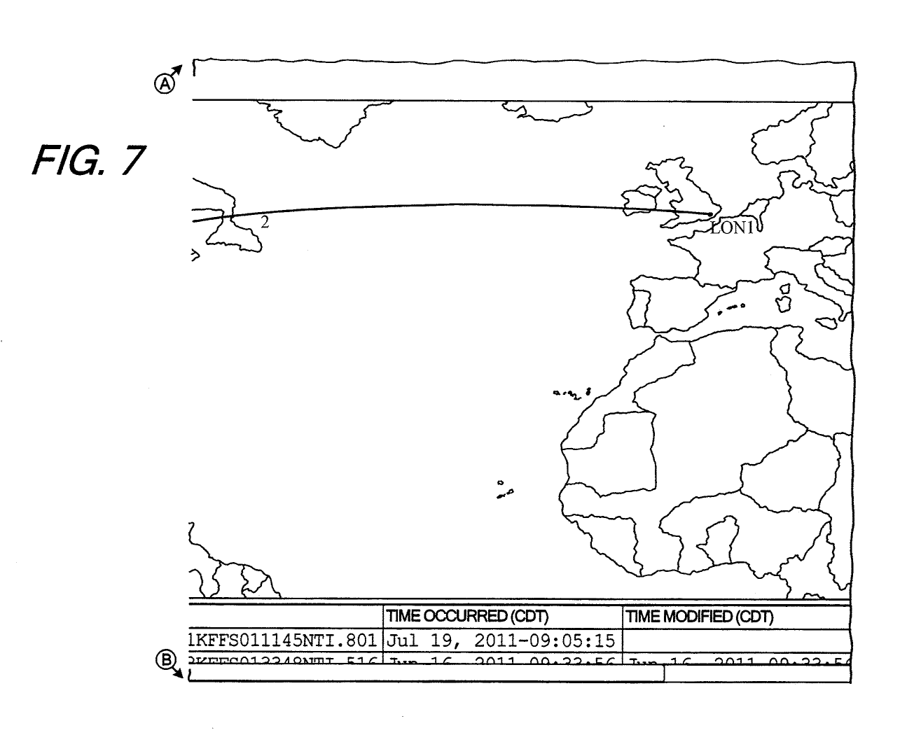

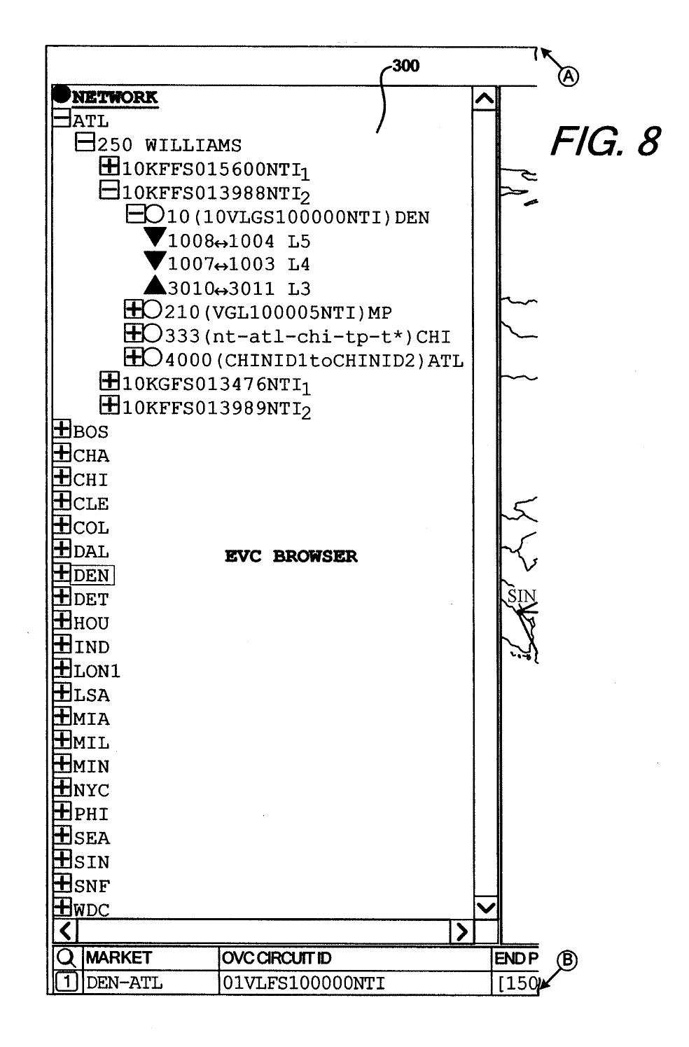

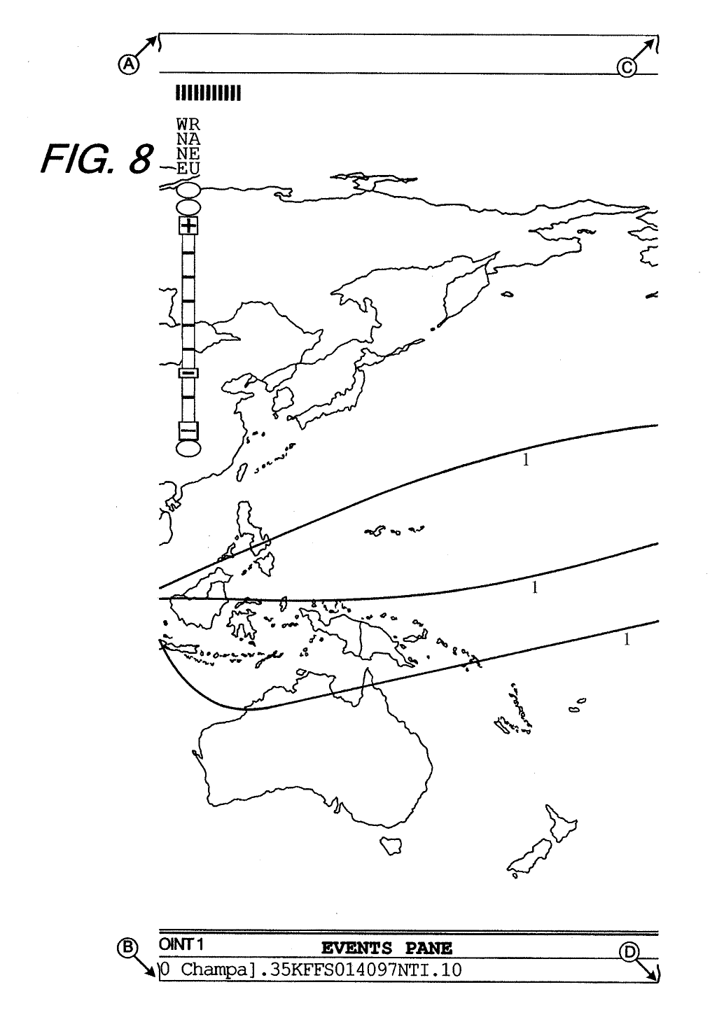

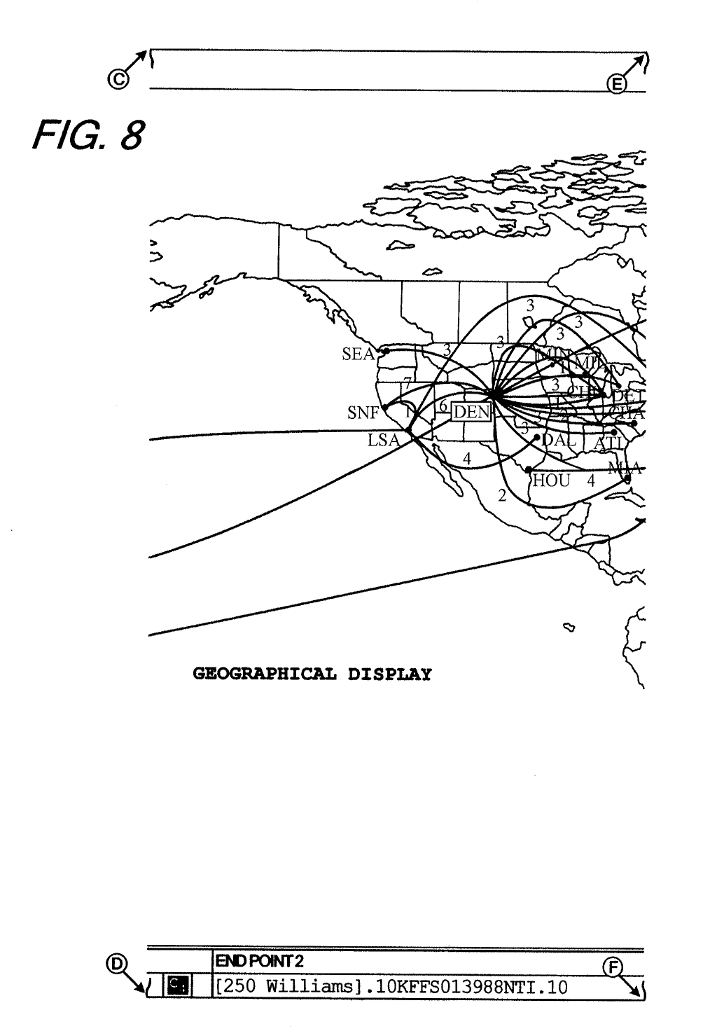

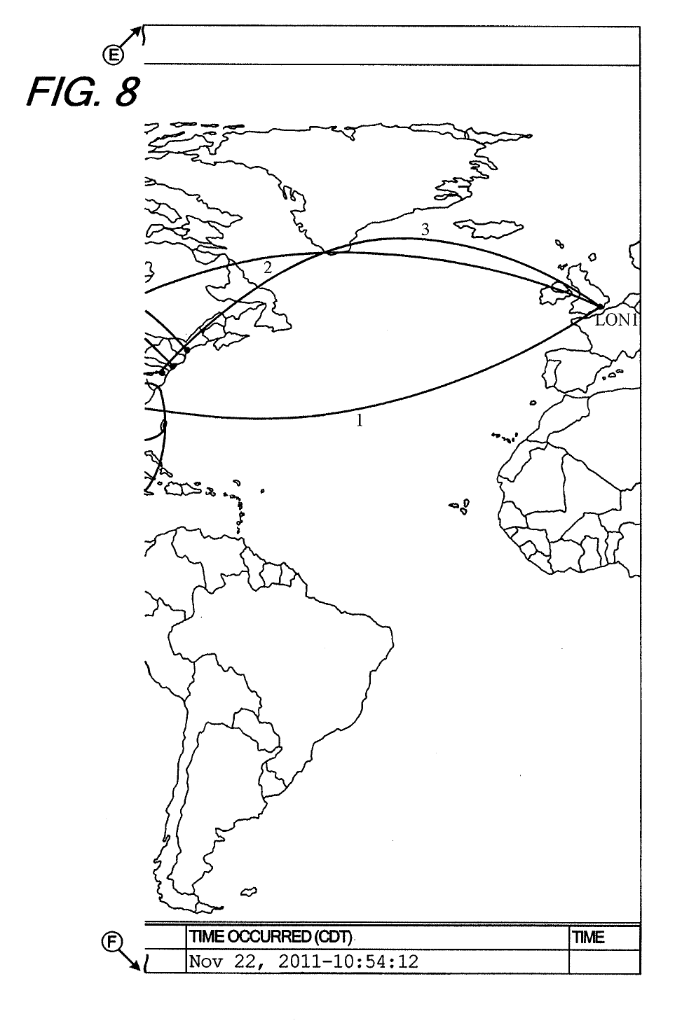

The monitoring system provides a plurality of interactive displays to provide users with real time network fault and performance information. A first such interactive display, referred to as EVC browser pane display 300, is shown in FIGS. 7 through 9. The EVC browser pane display 300 displays information regarding the networks in a hierarchal manner. As shown in FIGS. 7, 8 and 9 a first display level 310 displays the network, a second display level 320 shows the markets comprising the network 310, which may be based on geographic areas, a third display level 330 shows a building address for buildings comprising the market 320, a fourth display level 340 displays the network to network interfaces (ENNIs) or ports, a fifth display level 350 displays the service end points and a sixth level 360 displays the maintenance end points. Certain display levels may be collapsed or expanded to show or hide the sub levels thereunder. For example, a market can be expanded to show the building addresses that comprise that market. Each display entry on this view contains an alphanumeric identifier of a portion of the network. For example, for a building, the identifier may be the address of the building, whereas, for an ENNI/port, the identifier may be a circuit identification number. Similarly, an maintenance end point may include an identifier identifying the local and remote maintenance end points correlating thereto.

Display levels may also have a numeric sublevel indicator 370 adjacent the alpha-numeric identifier to identify the number of the sub portions of the network stemming therefrom. For example, as shown in FIG. 7, on line 340, the number “1” indicates that there is one service end point for the ENNI/Port identified on line 340. For maintenance end points displayed on the sixth level 360, there may also be displayed a domain level 380 indicator corresponding to the maintenance domain level corresponding to that maintenance end point.

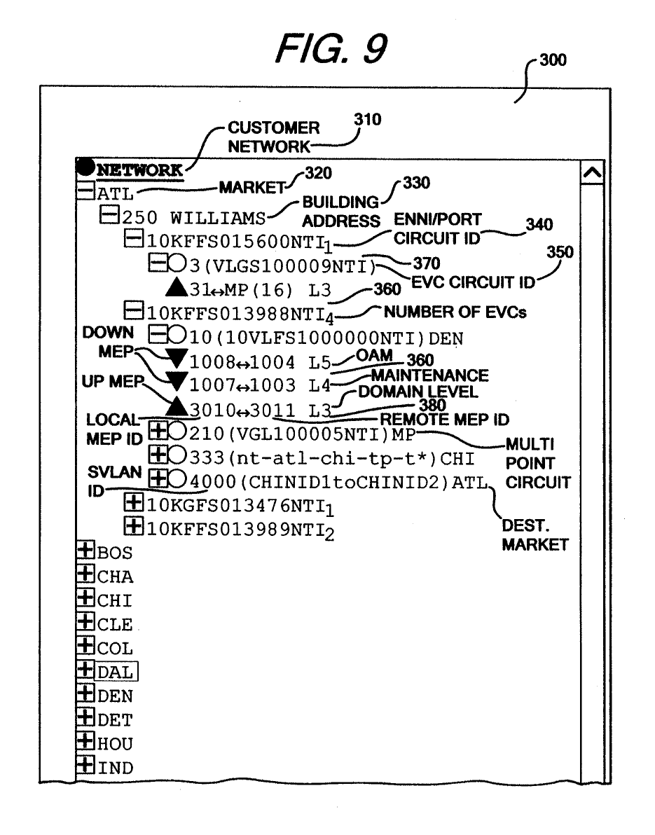

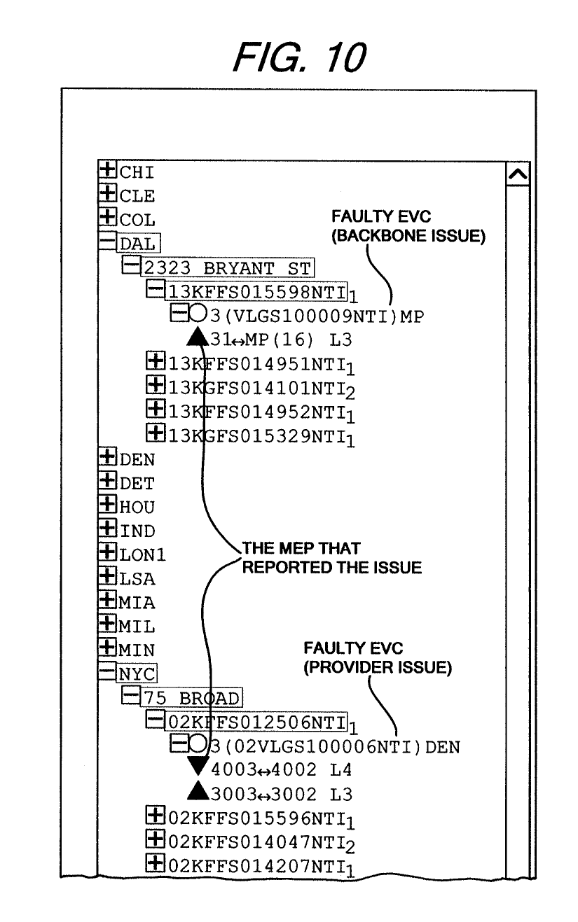

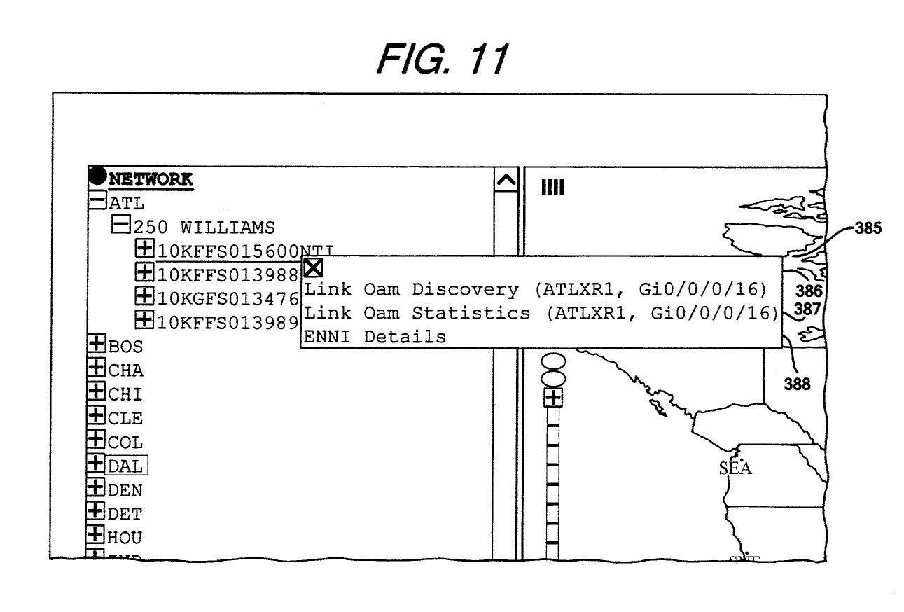

In another aspect of the EVC browser pane display 300, color coded error reporting is provided at multiple levels of the network. This allows a user to quickly pinpoint locations on the networks at which errors are occurring. As shown in FIGS. 9 and 10, this can be accomplished by a variety of visual display tools including highlighting or the use of symbols. Different colors may be used to indicate different error locations. For example, a market highlighted red may indicate an error in the central network, whereas a market highlighted orange may indicate an error at the provider or end customer network.

In another aspect of the EVC browser pane display, a plurality of functions for obtaining detailed information regarding specific portions of the network are provided. In one embodiment, these are provided by way of drop down menus 385 that appear when a user clicks on one of the alphanumeric identifiers for one of the network components. As shown in FIG. 11, the identifier for a network to network interface may be clicked to provide a menu 385 of network to network interface assessment functions 386-388. The following functions are available in the network to network interface menu: Link OAM discovery 386, Link OAM statistics 387 and ENNI/Port details 388. Link OAM is defined in IEEE 802.3ah standard, which is incorporated in its entirely herein by reference.

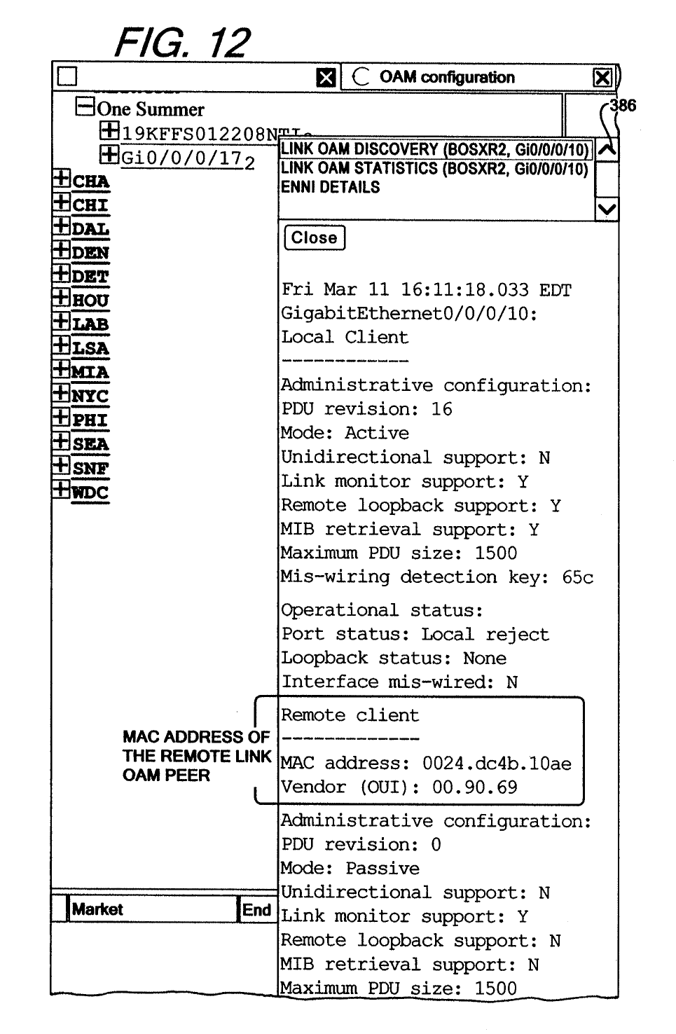

The Link OAM discovery function 386 enables a user to send an active link OAM discovery command to the central network router 110. The discovery is then performed on the physical interface associated with specific ENNI. Usage of this function requires a Link OAM configuration to exist on the interface. As shown in FIG. 12, the discovery process returns useful OAM information about remote as well as local peers: remote MAC address, OAM profile configuration, and OAM capabilities.

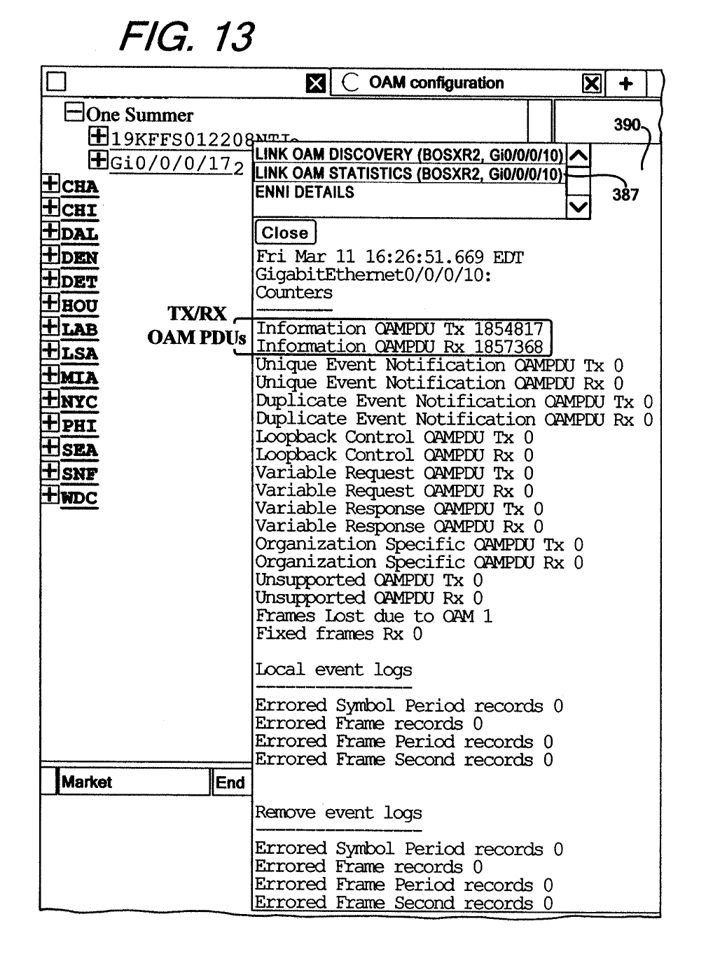

FIG. 13 shows a sample of the Link OAM status and statistics function results 390. As shown in FIG. 13, the Link OAM status and statistics function provides to the user statistics about link OAM status and protocol data unit (PDU) exchange. As shown in FIG. 13 it also provides information regarding notifications and loopbacks, as well as information regarding frames lost of fixed frames, errors detected on the link, number of errors detected locally, number of errors detected by the remote OAM peer, number of transmitted and received error/event notifications, number of transmitted and received MIB variable requests, number of transmitted and received unsupported OAM frames.

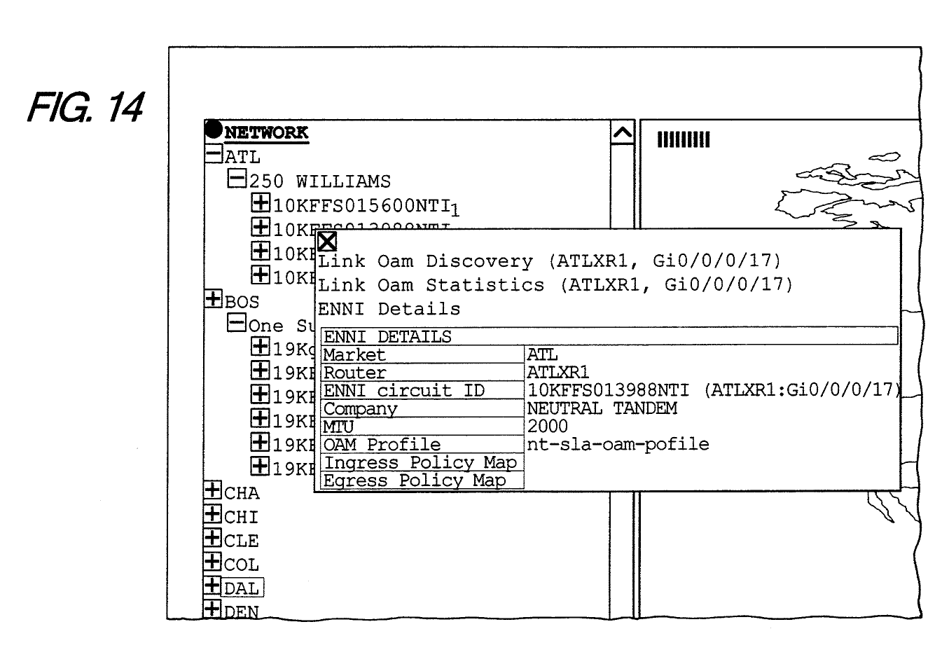

FIG. 14 shows a sample of the results 393 of the ENNI/Port details function 388. As shown in FIG. 14, the ENNI/Port details function provides the user with information related to the selected ENNI/Port, such as the maximum transmission unit (MTU), circuit identification, company name, link OAM profile name, and class of service (CoS) mapping information.

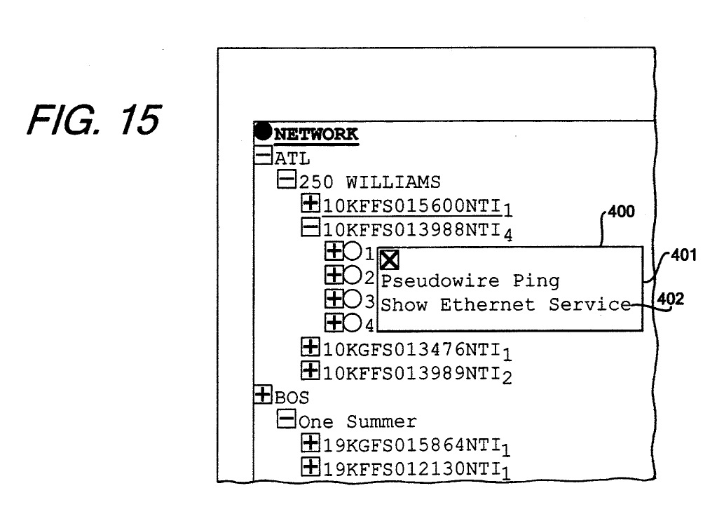

FIG. 15 shows a function menu 400 for a service end point also referred to herein as an EVC/OVC end point. As shown in FIG. 14 the service end point function menu provides multiple functions including a Pseudowire Ping function 401 and a Show Ethernet Service function 402.

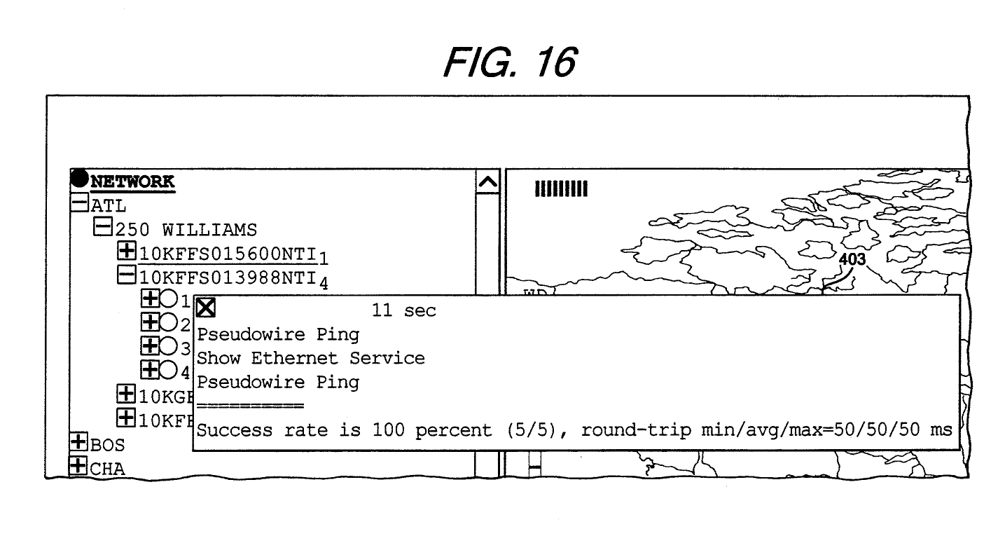

FIG. 16 shows the resultant display for a successful Pseudowire Ping 403. The Pseudowire Ping function is one of the Active Fault Detection, Isolation, Diagnostics, and Verification (AFDIDV) toolset. It functions over the central network multiprotocol label switching (MPLS) backbone, giving the user an instant ability to ping the remote end of the EVC/OVC using layer 2 OAM frames only. This functionality verifies the OVC connectivity over the central network. A successful ping will clear a false alarm received on the OVC end point.

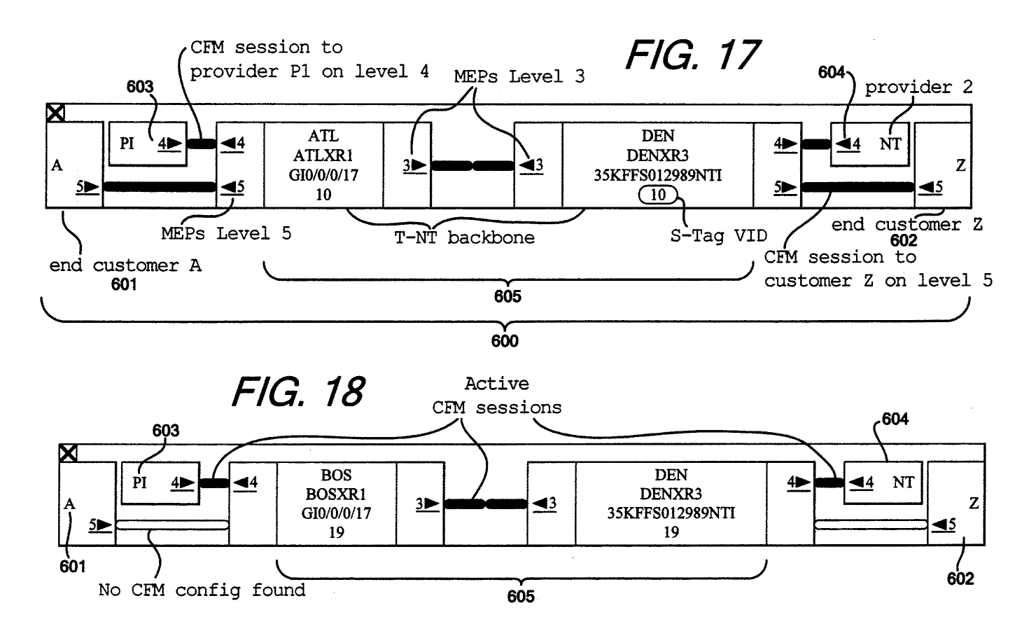

FIGS. 17-18 show exemplary displays of the Show Ethernet Service function. As shown in FIG. 17, the Show Ethernet Service function provides a display of an end-to-end single EVC 600. FIG. 17 shows a display for two end customers 601 and 602, two provider networks 603 and 604, and the central network backbone 605. This display is based on the available OAM MEPs on the provider as well as the end customer devices. The links between the components of the network are displayed in a first color or other indicia, and in a particular embodiment the color green, when the links are operational and an OAM configuration exists. In the cases where the service provider or end customer does not provide peer MEPs, the corresponding links will be displayed in a second color or other indicia, and in a particular embodiment the color gray. FIG. 18 illustrates an exemplary display in which the providers 603 and 604 are peering with central network 605 on level 4; however the end customers 601 and 602 are not peering at level 5. In the case of a network fault, the link corresponding to the portion of the network having the fault may be displayed in a third color or other indicia, and in a particular embodiment the color red, thereby providing a visual indication of the location of the fault.

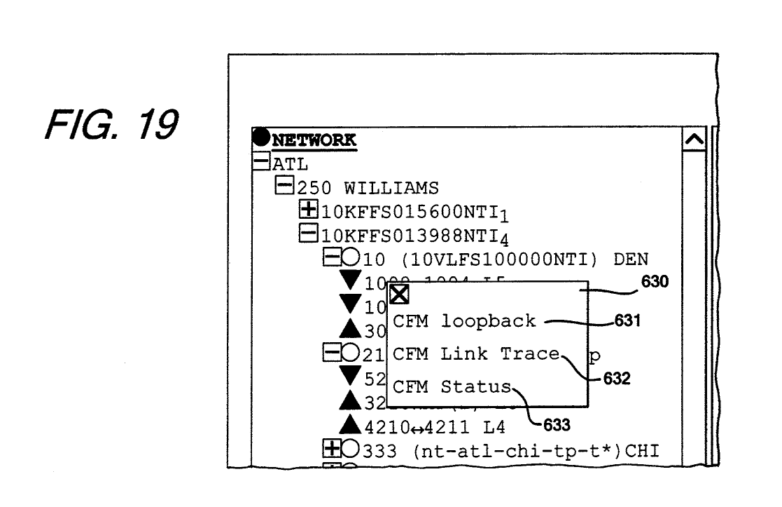

As shown in FIG. 19, another function menu, namely an MEP function menu 630, is provided for the maintenance end points 360. Clicking on any of the active MEPs displayed in the EVC browser pane display will invoke the MEP function menu 630. As described in more detail below, the MEP function menu lists functions that can be performed on each MEP. As shown in FIG. 19, in this particular embodiment, the CFM loopback, CFM Link Trace and CFM status functions are provided.

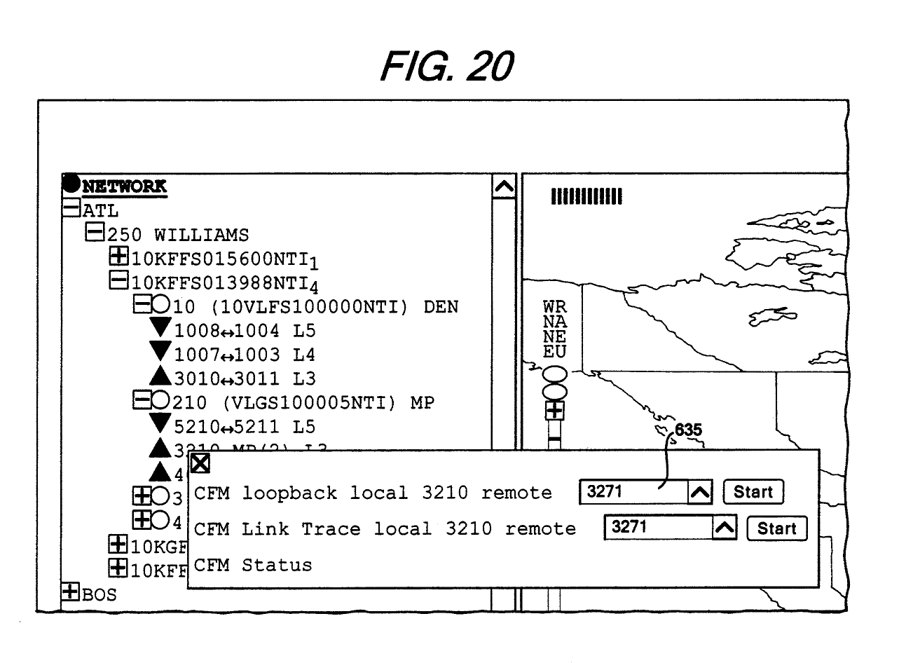

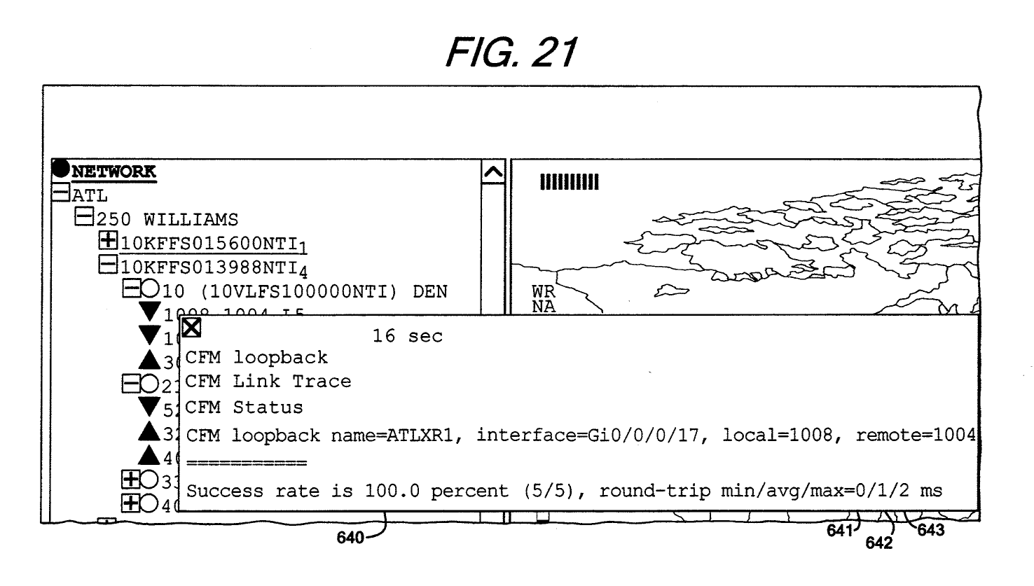

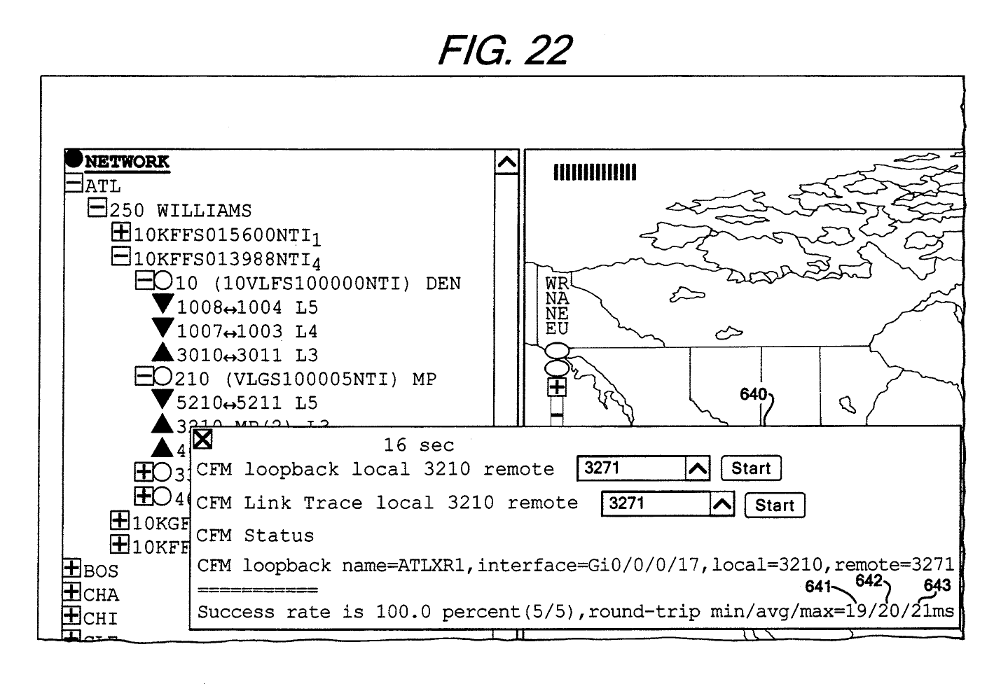

The “CFM loopback” function 631 can be used to verify remote end connectivity. This function initiates a plurality of CFM LBMs (loopback messages) from the selected local MEP to a targeted remote MEP. As shown in FIG. 20, in the case of a multipoint circuit, a user can select the targeted remote MEP from a drop-down box 635. The remote MEP responds by sending a loopback response (LBR) per each LBM received. If LBMs are successfully sent and a predetermined acceptable number of LBRs are received back, a fault displayed on the OVC will considered as false alarm or due to configuration reasons that do not affect network connectivity and therefore the fault will be cleared. For example if 5 LBMs are sent and 3 or more LBRs are received, the fault will be cleared. As shown in FIGS. 21 and 22, once the CFM loopback function is performed, the interface may display the results of the loopback including a success rate showing the number and percentage of LPR's received 640, as well as the time for the minimum, average and maximum round trip loopbacks 641, 642 and 643, respectively.

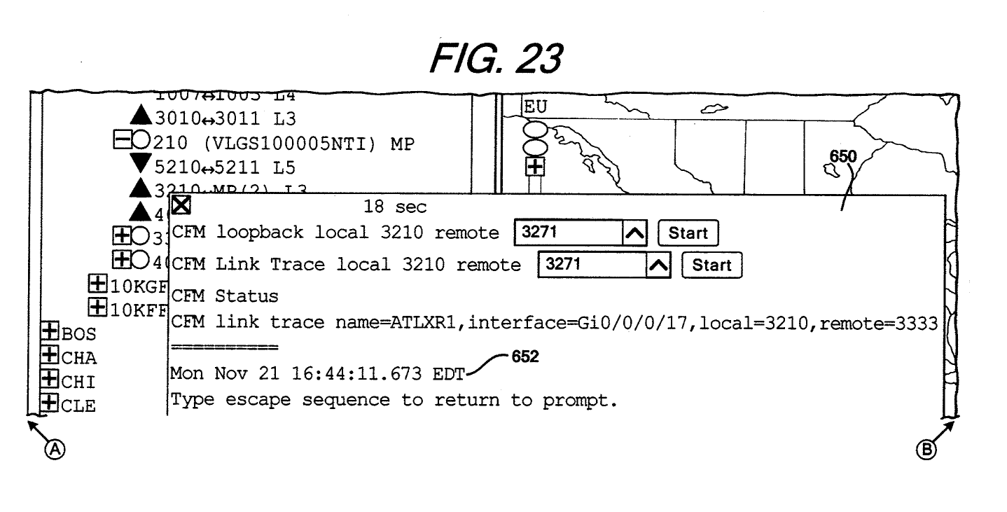

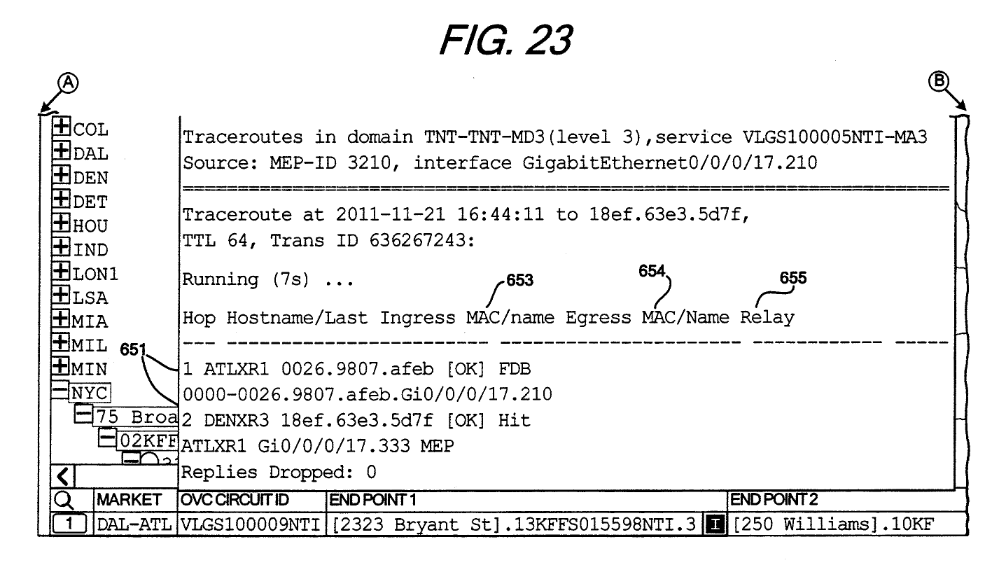

As shown in FIG. 19, the CFM Link Trace function 632 may also be provided in the MEP function menu 630. This CFM Link Trace function 632 initiates an Ethernet CFM link trace operation on the selected MEP. When a user clicks on this function, a Link Trace Message (LTM) is sent from the MEP on the router interface where the MEP is configured to the selected target remote MEP. If the link trace is successful, a link trace reply (LTR) is received back from the target MEP. In addition, all the Maintenance Intermediate Points (MIPs) on the path to the MEP will send LTRs as well. This mechanism may be used to isolate the faulty portion of the network. As shown in FIG. 23, the CFM Link Trace function provides an output display 650. The output display 650 shows the number of hops for each link trace reply 651. A hop means the LTM message was captured by a MIP or MEP and a LTR response has been sent back to the originating MEP. Other output information displayed may include the time and the date of the link trace 652, an identifier of the ingress medium access controller (MAC) 653, an identifier of the egress MAC 654 of all of the MIPs and MEPs responding to the LTM, and an identifier of the relay 655. In addition, the output display identifies the number of link trace replies dropped 653, if any.

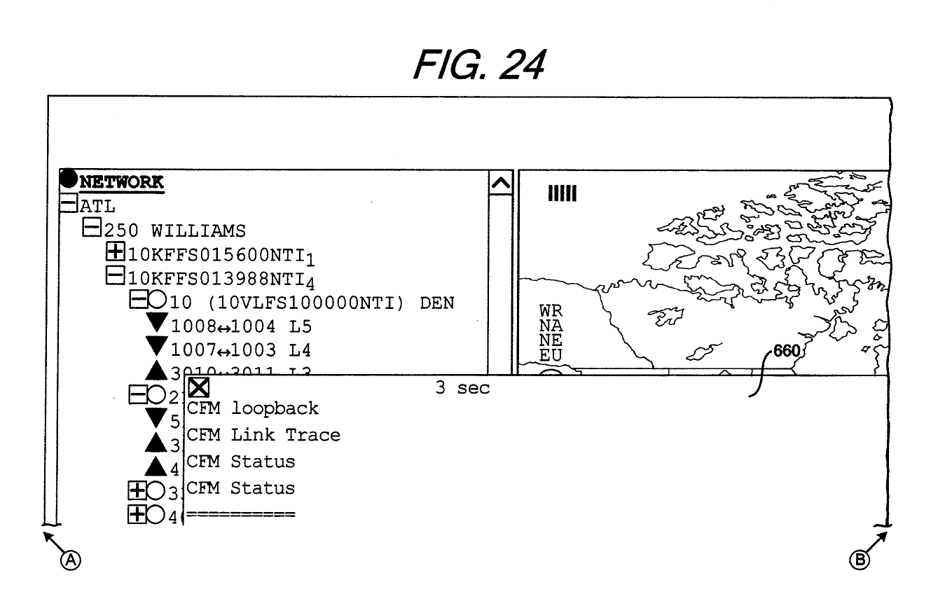

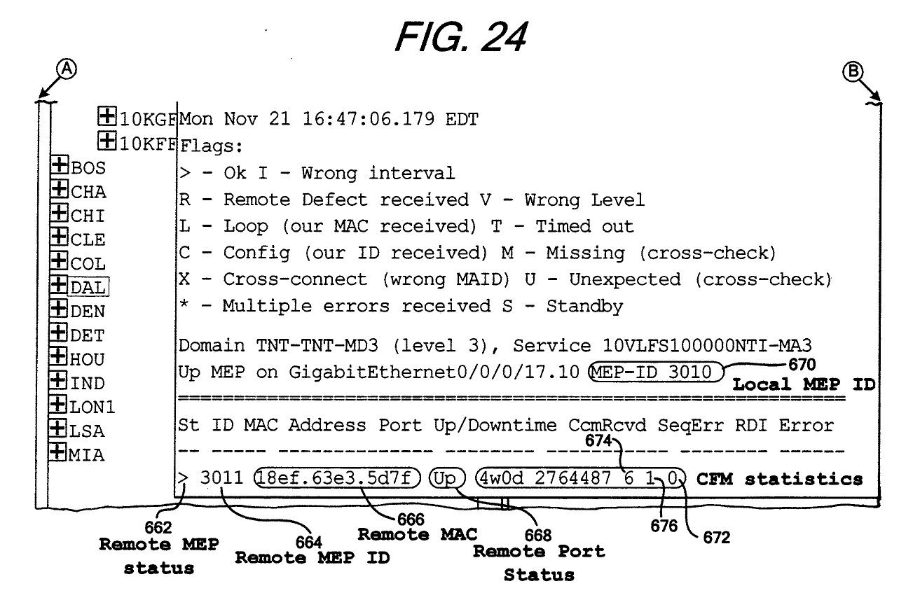

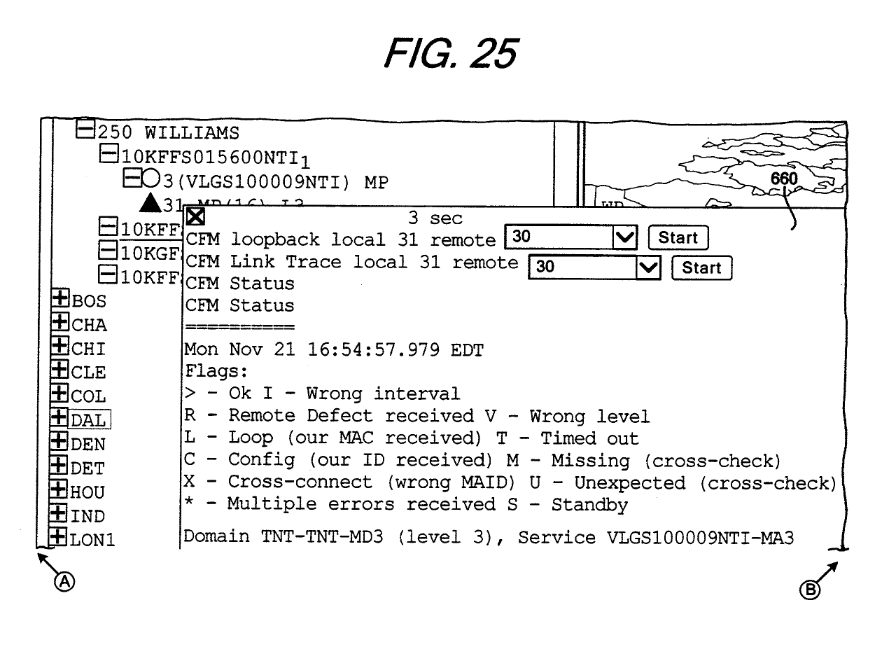

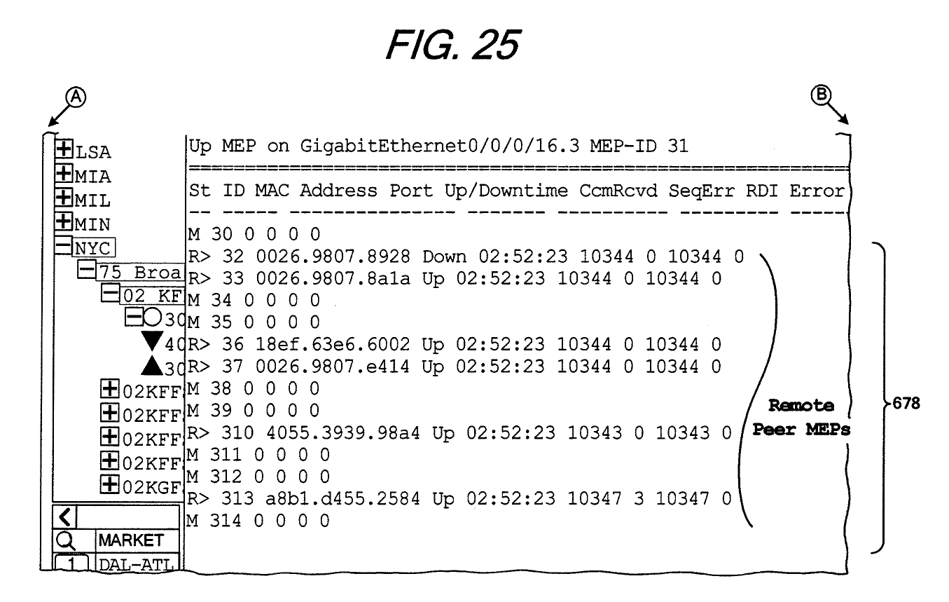

As shown in FIG. 19, the CFM Status function 633 may also be provided in the MEP function menu 630. This function may be used to collect status and statistic information from the selected local MEP. As shown in FIG. 24, the CFM status function provides an output display 660. The output display contains a MEP status indicator 662 indicating the status of the remote MEP, an identifier of the remote MEP 664, an identifier of the MAC for the remote MEP 666, and an indicator of the status of the port corresponding to the remote MEP 668. The output display may also provide an identifier of the local MEP 670. The statistics are based on the continuity check messages (CCMs) exchanged with the remote MEP. The output also may show errors 672, out-of-sequence CCMs 674, and remote defect indication (RDI) errors 676, such as a receive signal failure at a downstream MEP. Advantageously, for networks having multiple peer MEPs, the output display 660 for the CFM status function will return the status of all remote peer MEPS 678 as shown in FIG. 25.

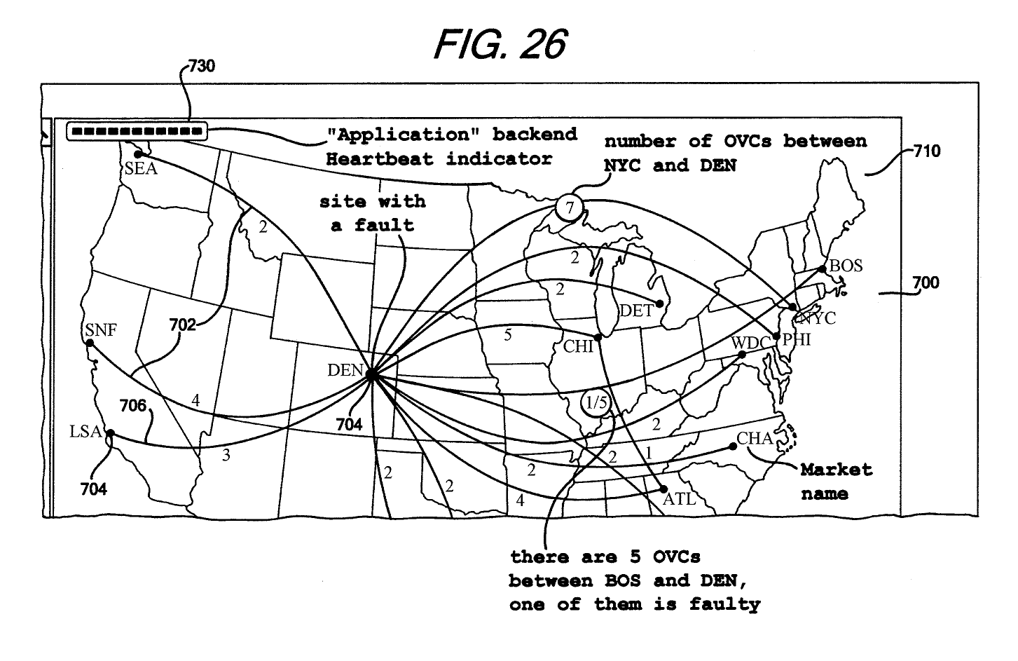

A second interactive display referred to as a graphical pane display 700 is shown in FIG. 26. The graphical pane display 700 presents a geographic overview of the various circuits 702. An exemplary geographic pane showing connections in North America is shown in FIG. 26; however, the geographic pane may display connections worldwide, or in any subgeographic configuration.

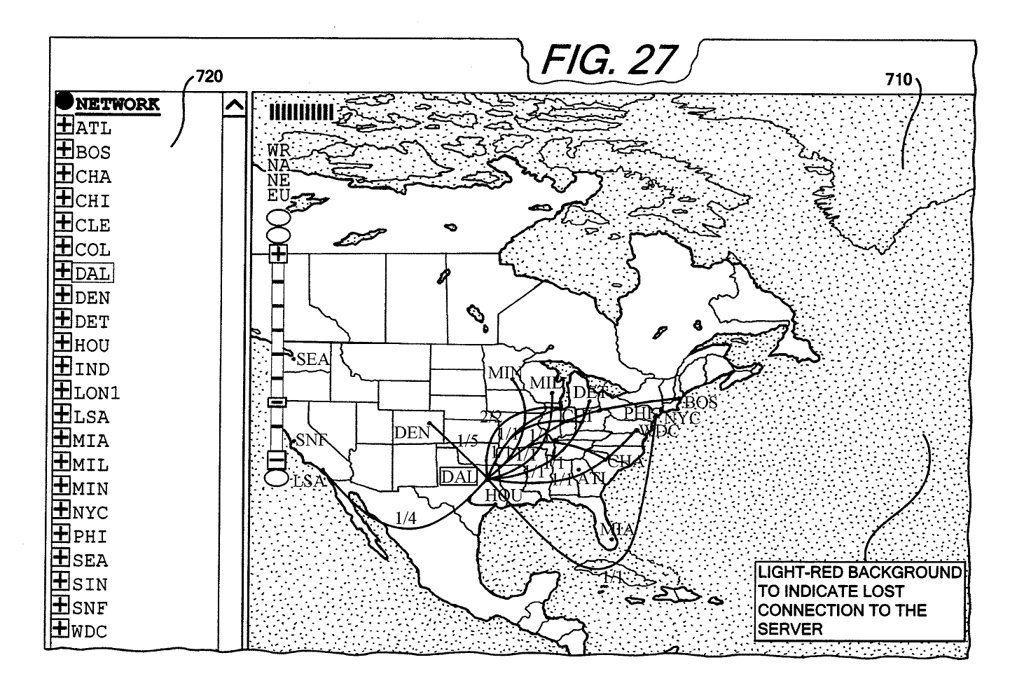

As shown in FIG. 27, the geographic pane has a main display portion 710, which shows the EVC portion on the central network backbone (tail segments or segments between the service provider and the CPE are not shown). In the embodiment shown, sites 704 are depicted by dots and connections between the sites are depicted by lines 706 connecting the dots. Only one line is shown between each of the two sites that has OVC end points and the actual number of OVCs between any two sites 704 is displayed numerically next to the line 710.

The geographic pane display provides a visual indicator of faults occurring on any given EVC. When a fault occurs on any portion of an EVC, the graphical display will reflect the fault on the corresponding OVC by changing the appearance of the trace line. For example, the trace line may normally appear black and change to red to indicate a fault. In addition, the display of the number of OVCs displayed on the line may be changed to indicate a fault. For example, as shown in FIG. 26, a second number may be shown to indicate the number of faulty OVCs. This number is preferably displayed in a different color, such as red, than the number indicating the total number of OVCs. The appearance of the dot representing the site that reports the problem may also be altered to indicate a fault, for example, by changing the color of the dot to red. The display may also provide a visual indicator to identify situation in which a fault has occurred only on a local connection. For example, the display may change the color of the site dot, but may not change the color of the line where the only fault has occurred locally meaning within the same market, or same router.

Also provided in the graphic pane display is a visual indicator 730 of the status of connectivity of the system server and the application providing the user display, i.e. the web browser. This visual indicator is referred to herein as the “heartbeat indicator.” The heartbeat indicator provides a visual real-time verification of the user's connection to the system server. In the embodiment shown in FIG. 26, the heartbeat indicator uses a row of bars to indicate the status of the connectivity; however, one of skill in the art will appreciate that other symbols may be used, such as, for example, vertical bars, horizontal bars, or other shapes. Each time increment, for example, one second, the heartbeat indicator displays a subsequent bar. If the connection is active the bar has a first appearance, for example, a blue color. If, on the other, hand, the connection is inactive, the bar has a second appearance, for example, a red color.

The heartbeat indicator has a refresh interval, for example, 30 seconds, after which the web browser will attempt to connect to the system server. The refresh interval may be set by the user. If the connection is successful, the browser will update the contents of the display and the indicator will be reset to zero. If, on the other hand, the browser is not able to connect to the server, the indicator, i.e., the bars, will indicate an inactive connection. Optionally, if the browser is not able to connect to a server for a predetermined second interval, for example twenty seconds, the entire indicator may take on the appearance that indicates an inactive connection. For example, the entire indicator may become red to indicate an ongoing loss of connectivity.

The map portion 710 of the graphical pane may also have a secondary visual indicator to indicate the loss of connectivity. For example, a loss of connectivity may change the color of the background of the map from white to red.

The map portion 710 of the graphical pane is also navigable via a zoom feature and a pan feature. The map portion of the graphical pane also permits additional user controls and displays. For example, the map portion of the graphical pane includes allows the user to save certain layouts and recall those layouts at a later time. In addition, a user can face alter the display of certain routes. For example, a user could “fade” or minimize the appearance of EVCs that do not have faults.

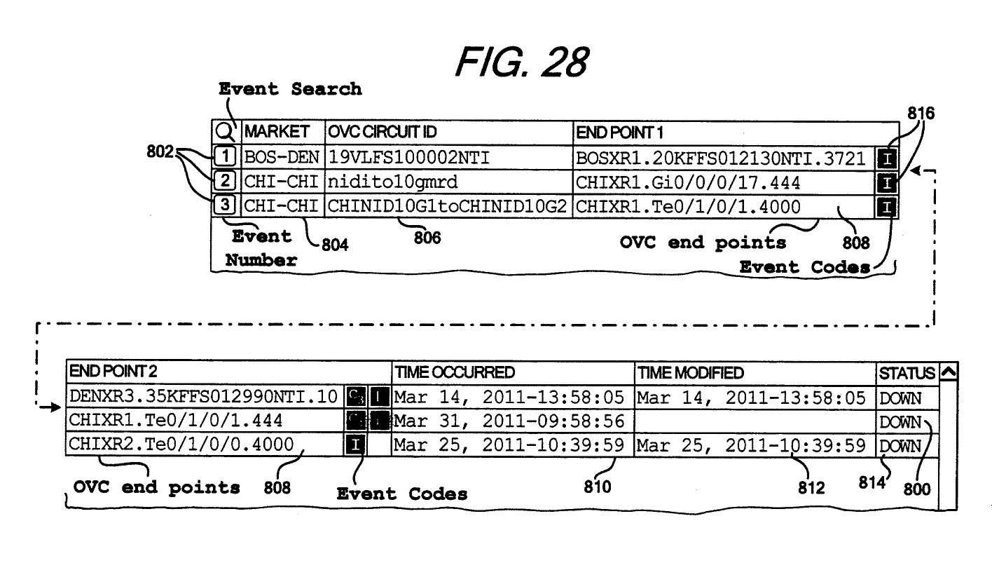

A third display, referred to herein as the event pane display 800, is shown in FIG. 28. The event pane display provides a tabular display of events. Associated with each event may be an event identifier 802, such as a number. Additional information relating to each event may also be provided within the tabular display. For example, as shown in FIG. 28, an identifier of the market 804, an identifier of the OVC/EVC circuit in which the event occurred 806, an identifier of the end points associated with the circuit 808, the time of the event 810 and the time that the event was last modified 812, as well as a status indicator 814 indicating whether the circuit is up or down may all be displayed.

Within the tabular display, different categories or types of events may be identified by different indicia correlating to the location of the event. For example, central network and link OAM faults, such as CFM faults occurring on level 3, psuedowire faults on the central network, and both the logical interface or sub-interface faults, as well as physical interface faults occurring on the central network, and a “down” condition for a link OAM session, may be identified by a first indicia, such as the color red. Faults detected outside of the central network, such as CFM level 4 and level 5 faults, may be identified by a second indicia, such as the color orange. in one embodiment, cleared faults may be identified by a third indicia such as the color green. The system may be configured to remove any display of the cleared faults after a set time interval.

In addition to or in place of such color coding, a second set of fault identifying indicia may be provided. For example, different alpha-numeric fault codes 816 may be used to identify the following types of events: faults detected by the psuedowire monitoring facility; faults detected by the physical and logical interface monitoring facility; faults detected by the Link OAM (802.3ah) monitor; faults detected by the CFM monitor on maintenance domain level 3 regarding the central network backbone; faults detected by the CFM monitor on maintenance domain level 4 (the service provider domain); faults detected by the CFM monitor on maintenance domain level 5 (the customer domain); and faults detected manually by performing a CFM loopback or psuedowire ping that resulted in a failure. The fault codes may also be color coded, such that when the fault is resolved, the appearance of the fault code changes, for example, from red to green.

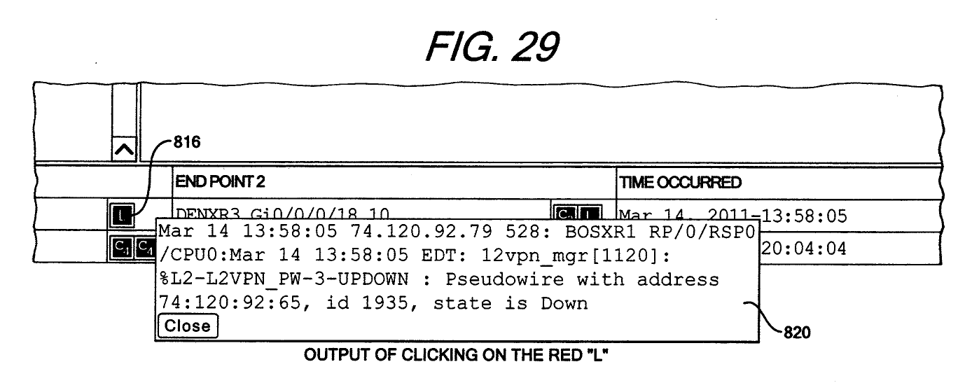

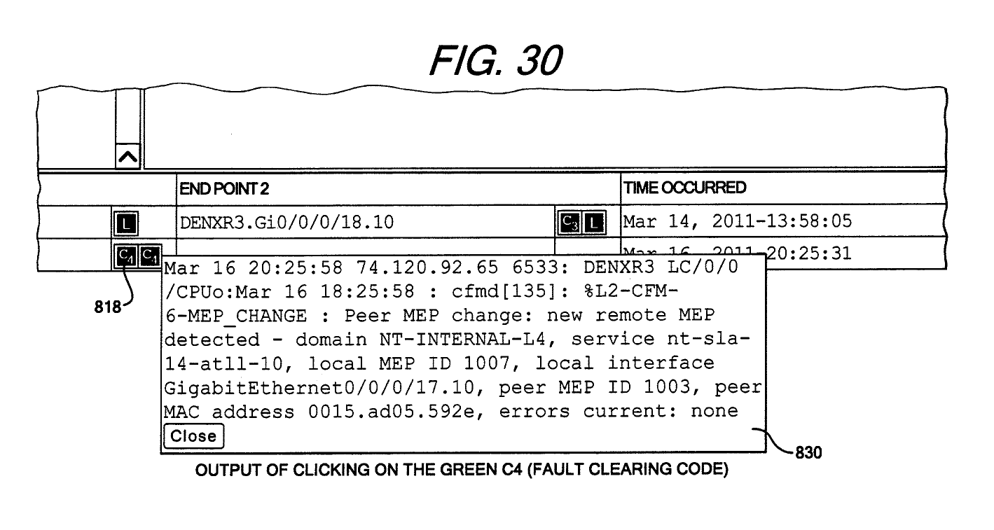

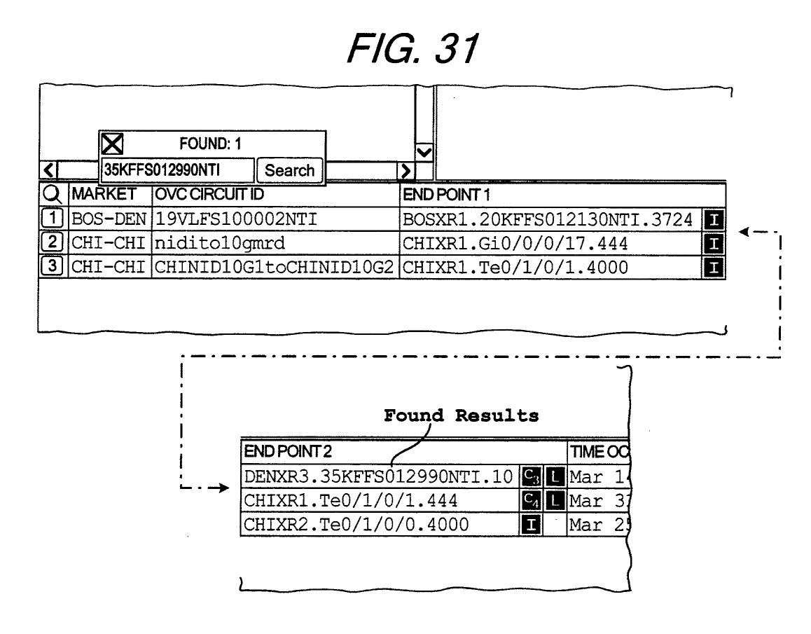

The fault codes may also be dynamic and linked to additional information, so that clicking on a red fault code will display the certain information relating to the fault as received from the monitoring facility. For example, as shown in FIG. 29, the date and time that the fault occurred, an address or other identifier of the location at which the fault occurred, and information regarding the type of fault may be displayed in a fault information display 820. Similarly as shown in FIG. 30, clicking on a green fault clearing code 818 will result in a fault clearing display 830 showing information regarding the event that cleared the fault and certain information relating to that event. For example, the date that the event occurred, the nature of the event that cleared the fault, the current status, and/or whether there are other errors may be displayed.

If multiple events/messages are received on the same EVC, the same entry will be updated by adding event codes (either fault codes, or fault clearing codes) and updating the “Time Modified” field.

The event pane display may also be searchable, enabling a user to search for a particular event, as shown in FIG. 31.

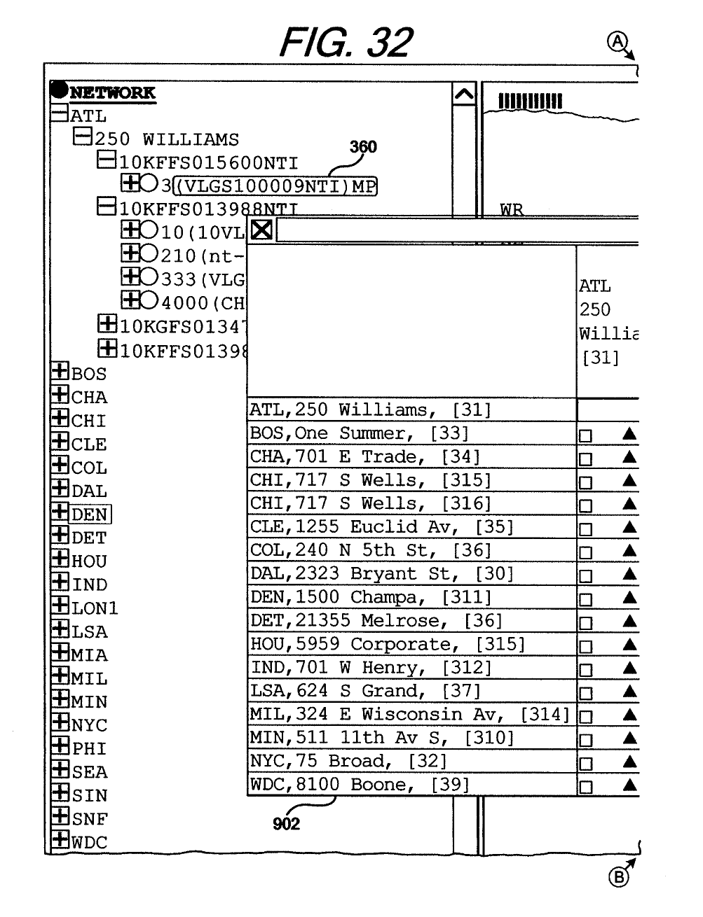

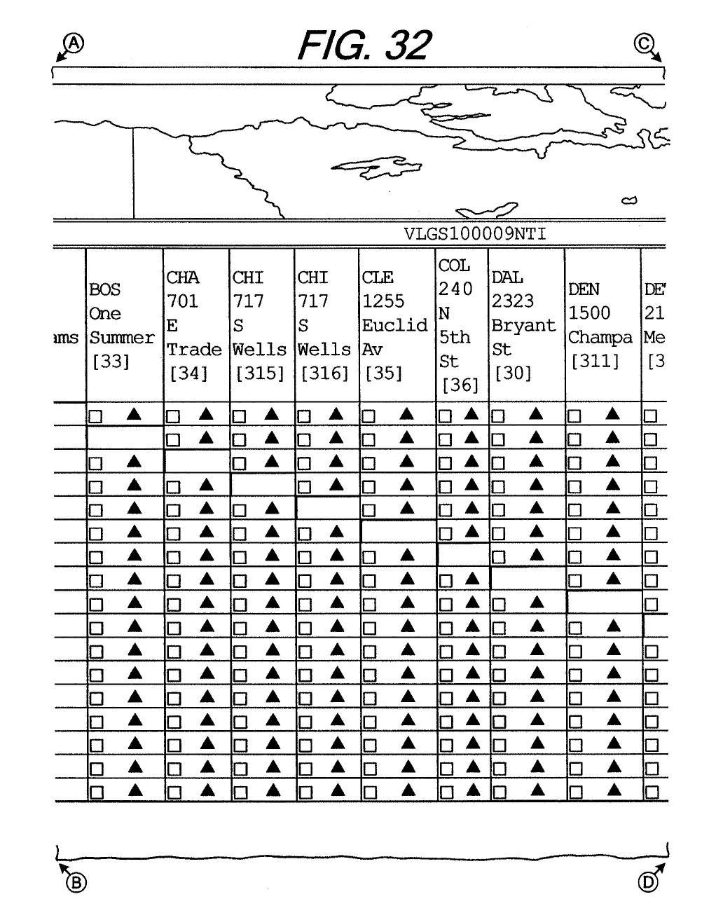

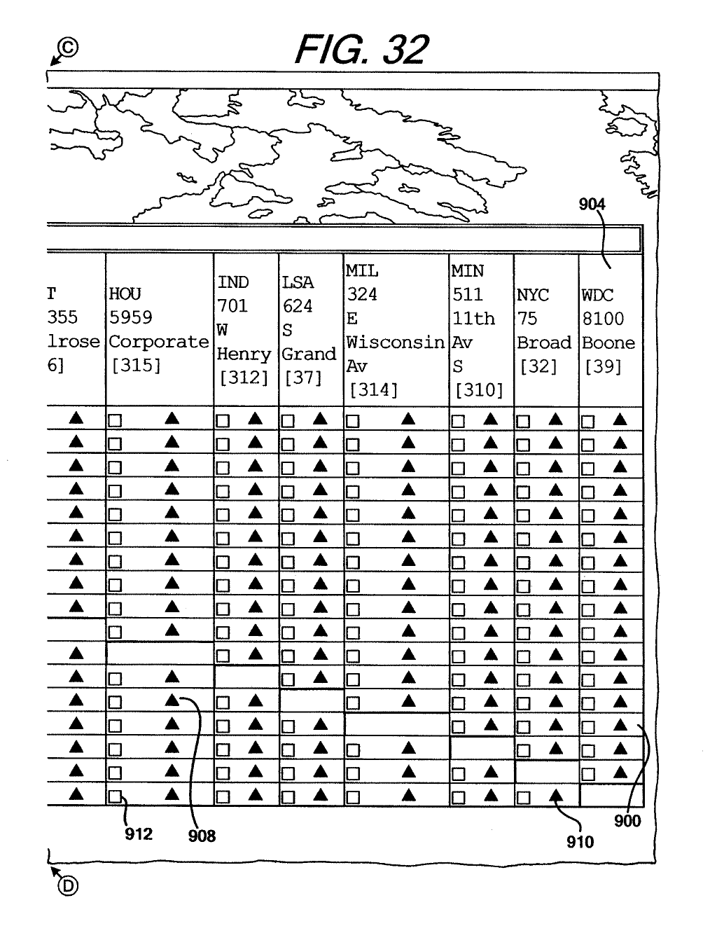

As shown in FIG. 32, the EVC browser pane also provides a matrix display 900 for showing users information regarding multipoint any-to-any (such as e-LAN and c-TREE) services. The multipoint view may be accessed by clicking a multipoint MEP 360 in the graphical pane view 300. As shown in FIG. 32, the end points of the multipoint circuit are listed across the vertical axis 902 and horizontal axis 904 of the matrix display 900. Body cells of the matrix 908 contain indicia identifying the status of the connectivity of the particular circuits between the end points. For example, as shown in FIG. 32, a mesh containing up-looking triangles (Δ) 910 indicating an up MEP covering the central network. These indicia may also be color coded or bear some another identification indicating the status of that network. For example, a red color may be used to indicate an MEP detected network error, whereas a green color may be used to indicate an MEP that does not have any errors. The indicia are also dynamic such that they are clickable and linked to the MEP function menu for that MEP, which, as discussed above provides a user with access to perform loopback, link trace, and show CFM statistics and status functions.

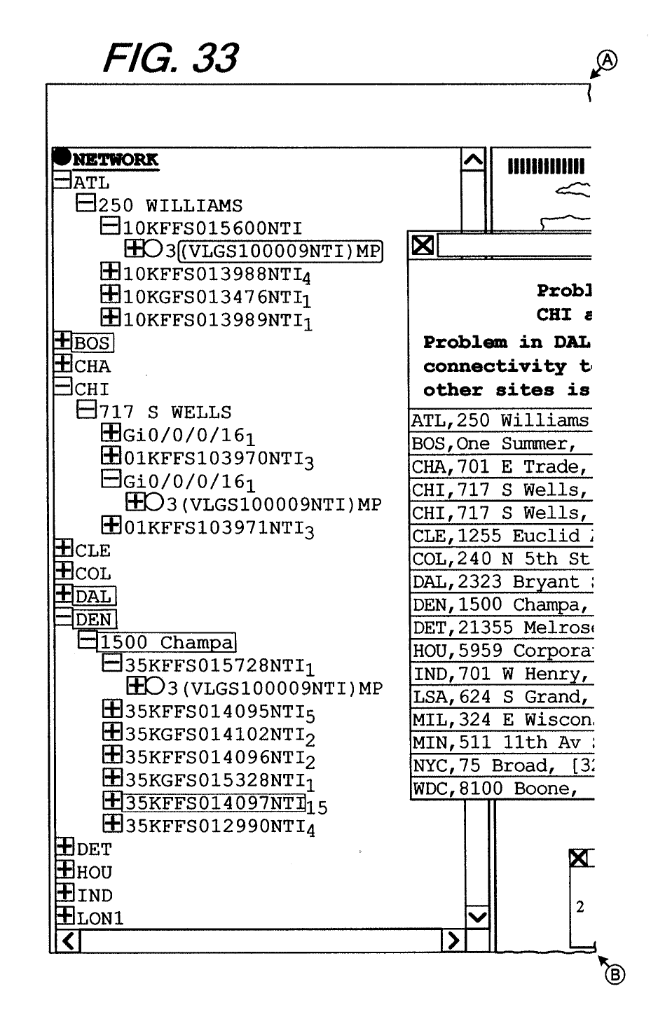

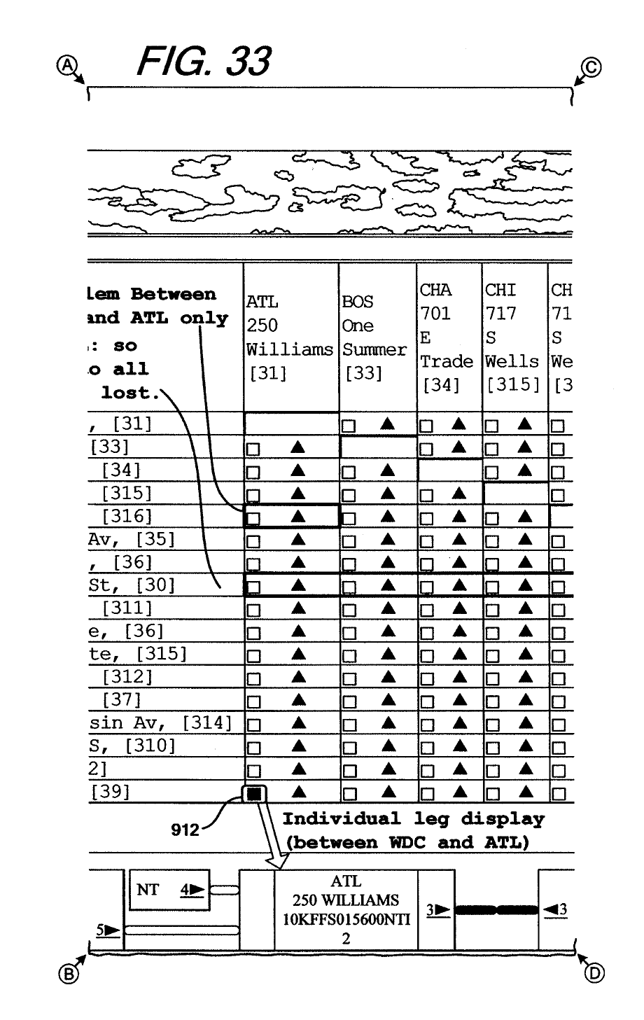

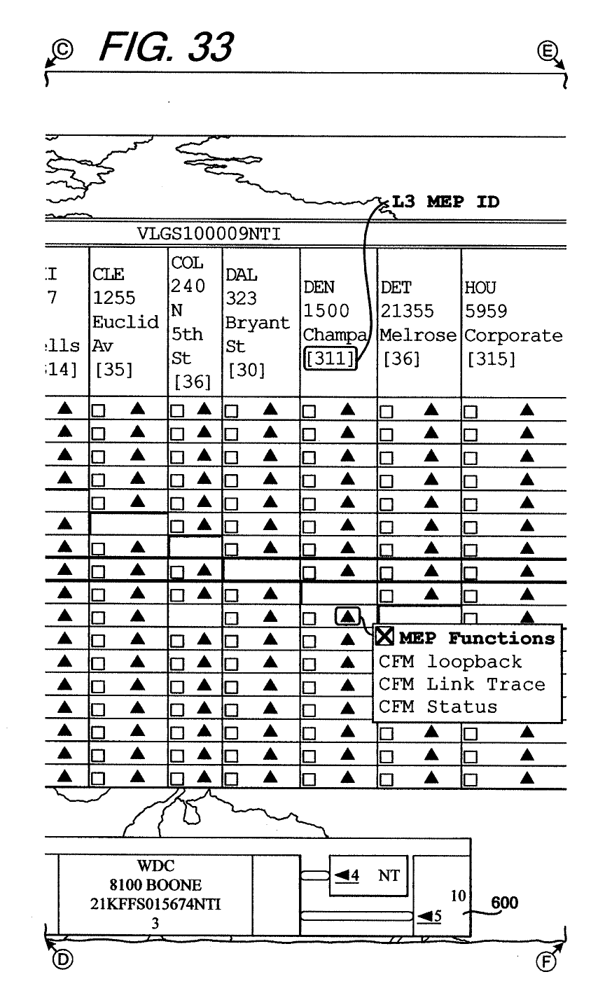

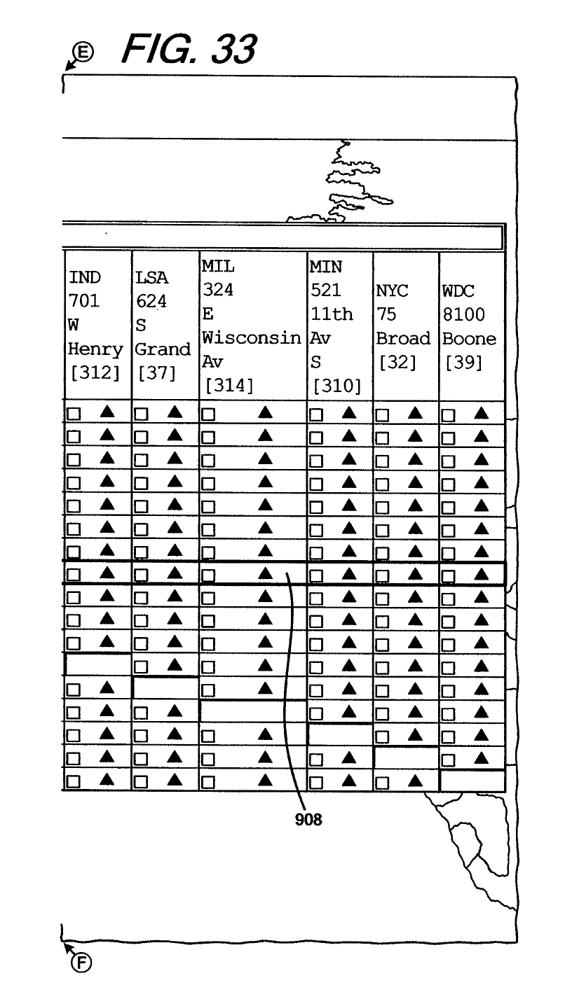

As shown in FIG. 33, the matrix also allows a user to open an end to end view display 600 for each connection of the multipoint circuit. A user can click on a square 912 associated with a certain cell 908 of the matrix 900 to open a display 600 showing the end to end view for the circuit corresponding to that cell. Once the icon is clicked and the end to end view is displayed, an indicator may appear in the cell to identify the cell for which the end to end view has been displayed. For example, the color of the square in the selected cell may be changed. The visual appearance of the cells may also be altered to indicate a network error. For example, as shown in FIG. 33 the background color of the cells 908 may be changed from white to yellow in cells corresponding to a network experiencing an error.

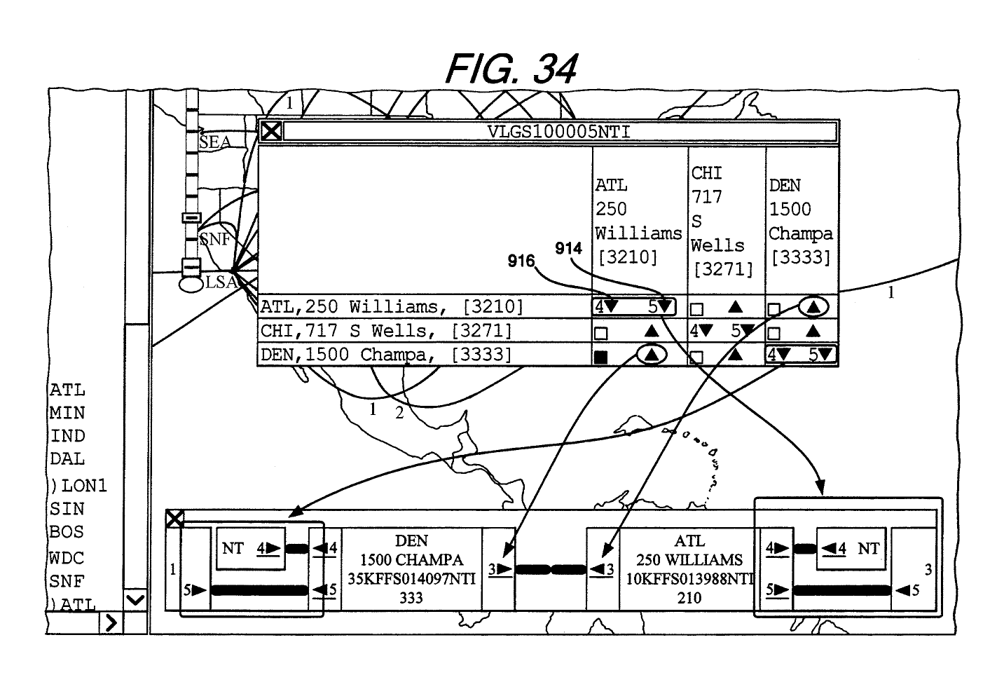

As shown in FIG. 34, the down MEPS looking towards the provider and customer (level 4 and level 5) may be displayed using indicia different than the indicia used for the up MEPS. For example, as shown in FIG. 34, they may be identified by down-looking triangles 914 and will be places in the diagonal cells 916 (which correspond to the port intersection with itself.)

The system also provides for communication of events to a predetermined set of email recipients. A user can input a list of addresses, such as email addresses, for the users to whom communications are to be sent. The user can also designate a certain interval at which communications regarding event information is sent to the list. In addition, the user can save this list to the system server, so that it can be used each time the user logs in. Alternatively, the user can save the list so that it is used for that session only.

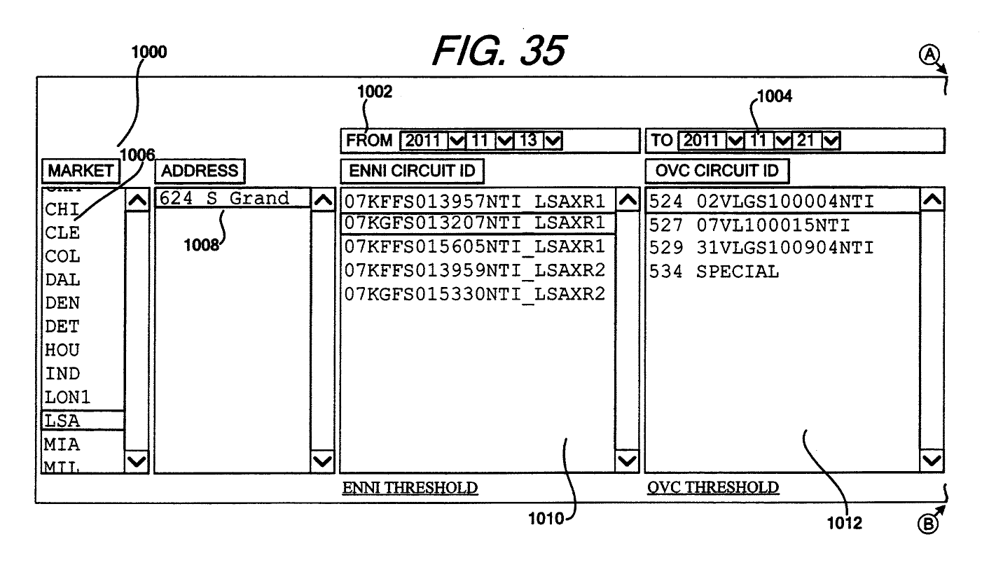

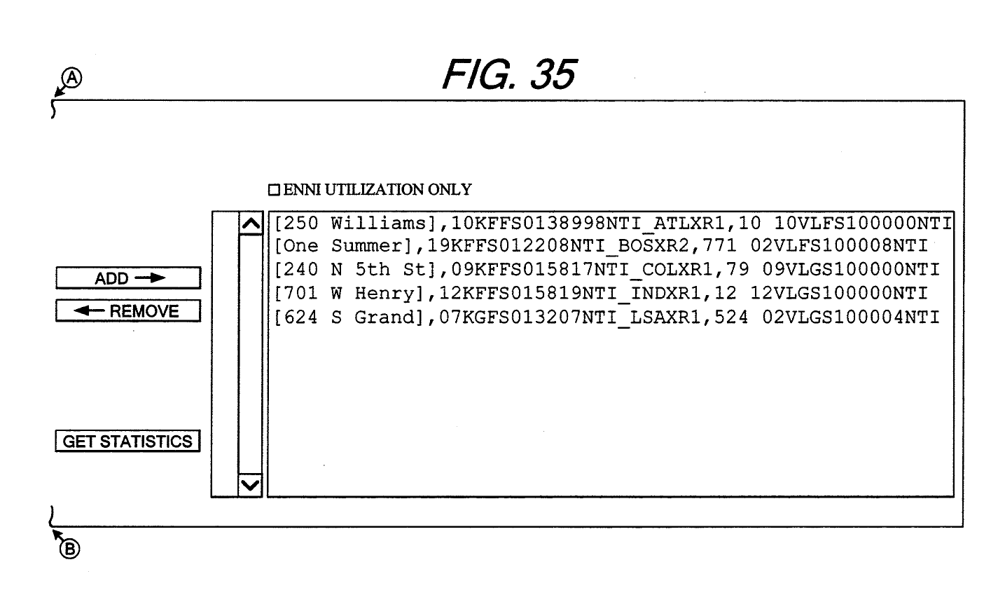

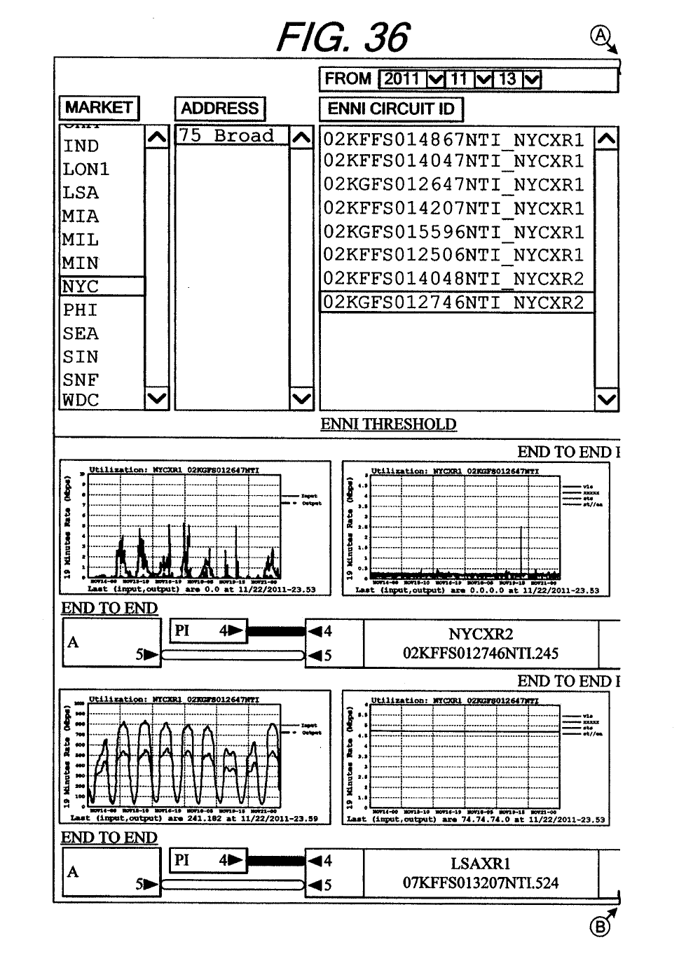

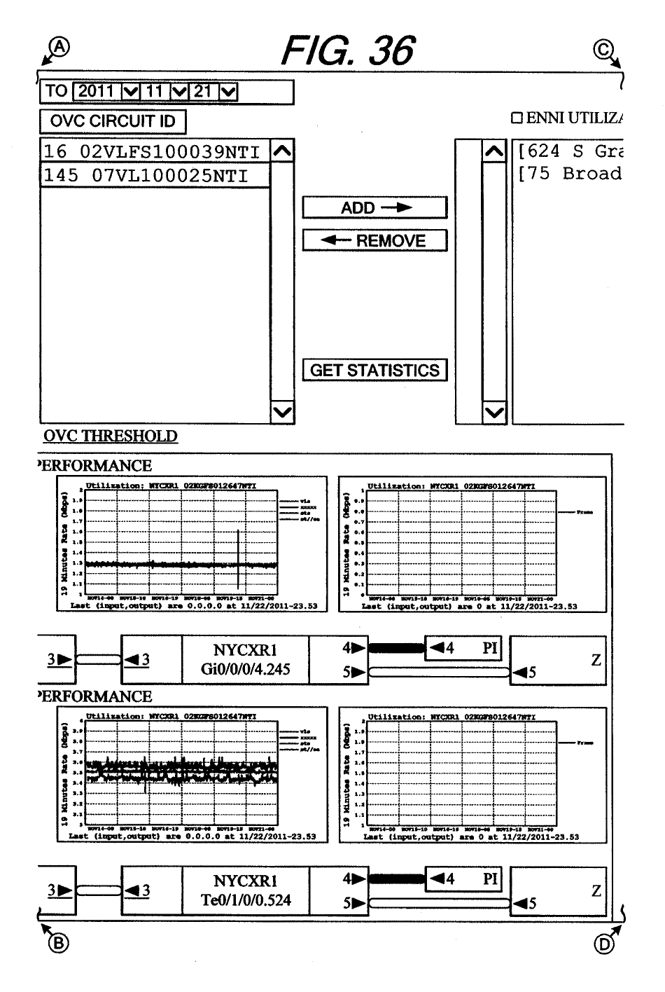

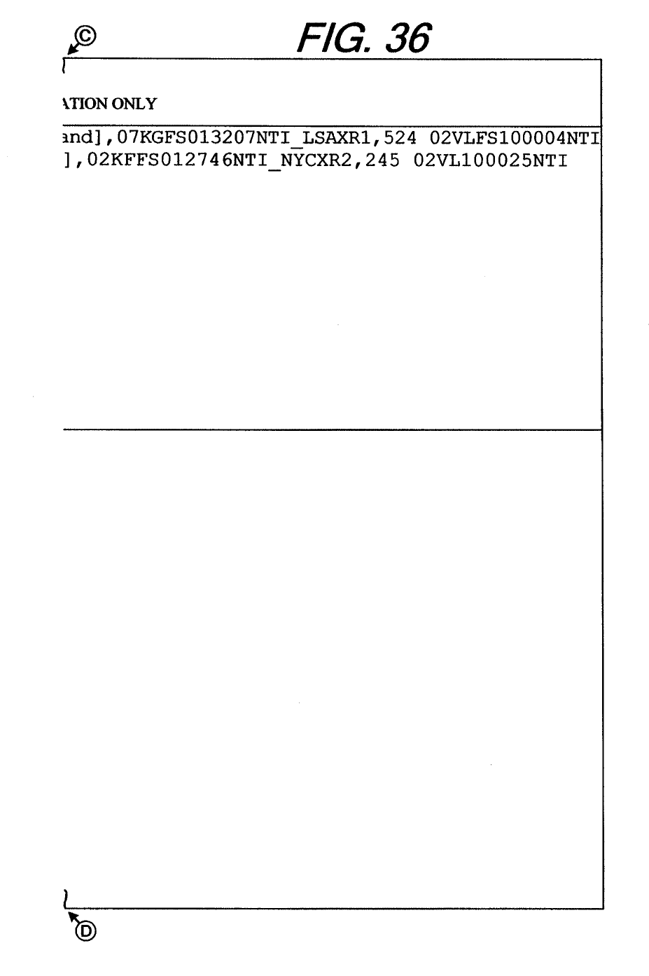

As shown in FIGS. 35-42 the system also provides performance management features. One aspect of the performance management feature provides for a performance management configuration display 1000 for creation of a user customized report regarding system performance over a user designated time period. As shown in FIG. 35 a user may configure the report by selecting the start time 1002 and end time 1004 for the reporting period from fields within the display 1000. The user may also select a plurality of circuits that for which data will be collected and reported upon, by designating the market 1006, address 1008, network to network interface or port 1010, and OVC/EVC 1012 for the selected circuits. As shown in FIG. 36, the report may display graphical data regarding per-EVC utilization 1020, per-EVC round trip delay 1022, per-EVC jitter 1024 and per-EVC frame loss 1026 in graphical form.

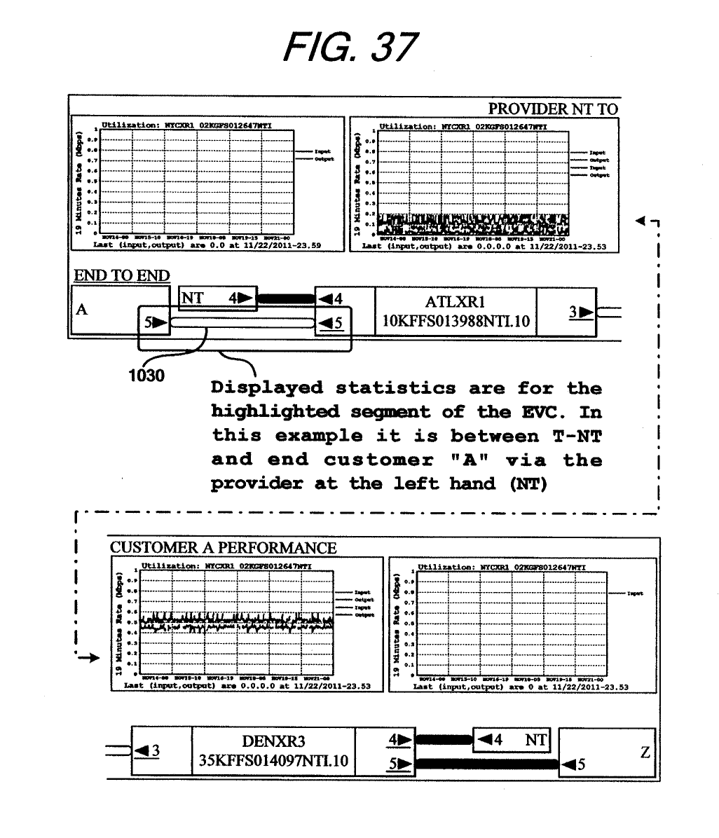

Along with the graphs showing the data, the performance management function also displays an end to end view of the circuit 600, which enables a user to break down the end-to-end performance statistics into segments corresponding to each portion of the total link. As shown in FIG. 37, a user may click on a specific segment link. For example FIG. 37 shows a display where a user has selected the link 1030 from the central network to the end user A, and so only performance data relating to that segment is displayed. The selected portions may be highlighted in a different color to show what segment is being displayed. The aggregation of these statistics provides the end-to-end SLA.

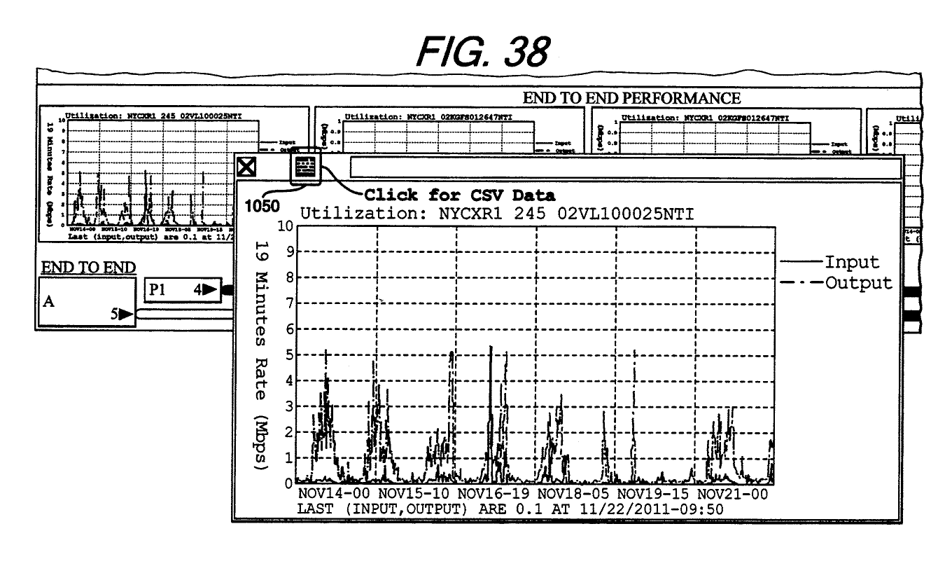

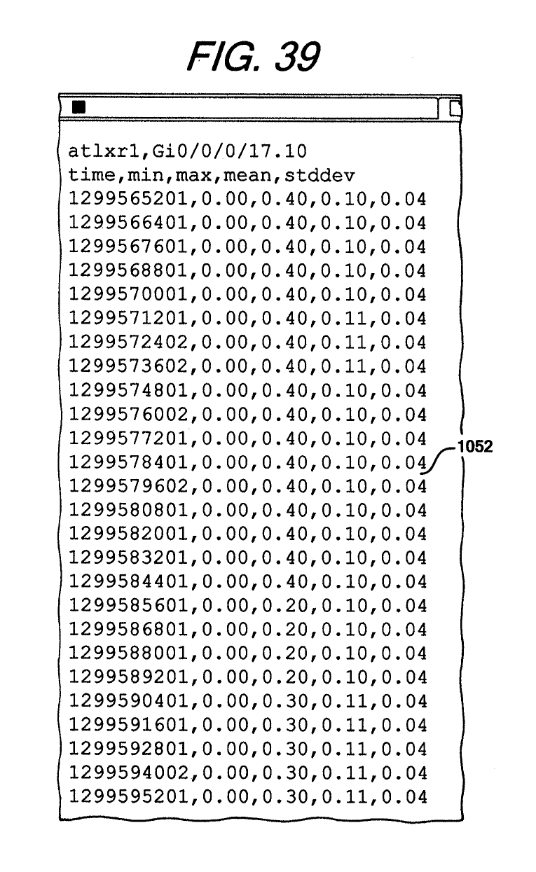

As shown in FIGS. 38, the display also provides a clickable link 1050 for a user to review the tabular data 1052, shown in FIG. 39, used to construct each graph.

The implementation of this performance management is based on Y.1731 standard protocol. As this standard is applied in the certain aspects disclosed herein, unique implementation allows for end-to-end as well as per-segment SLA monitoring and service assurance for individual EVCs.

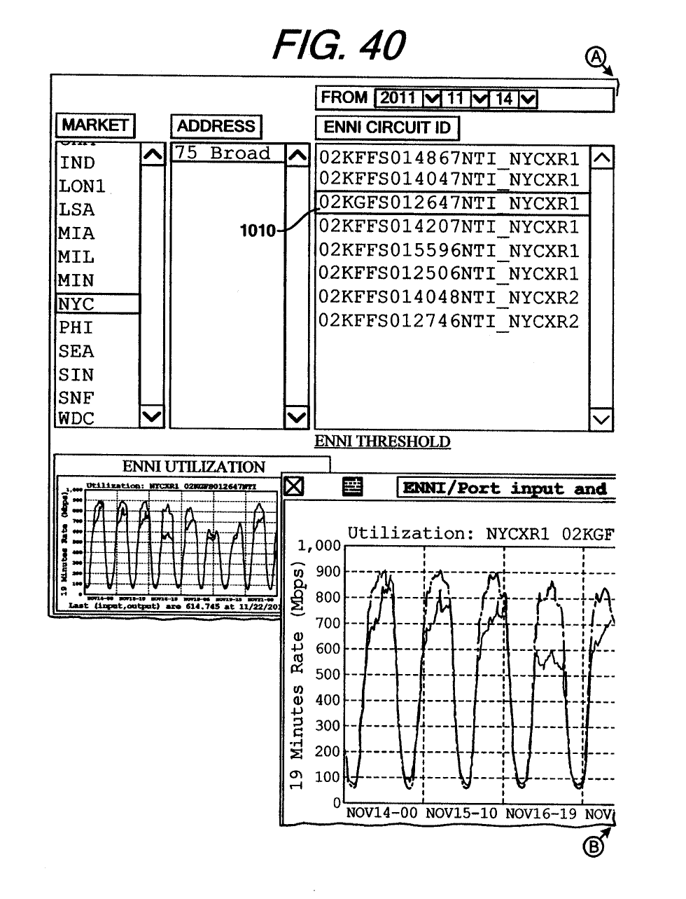

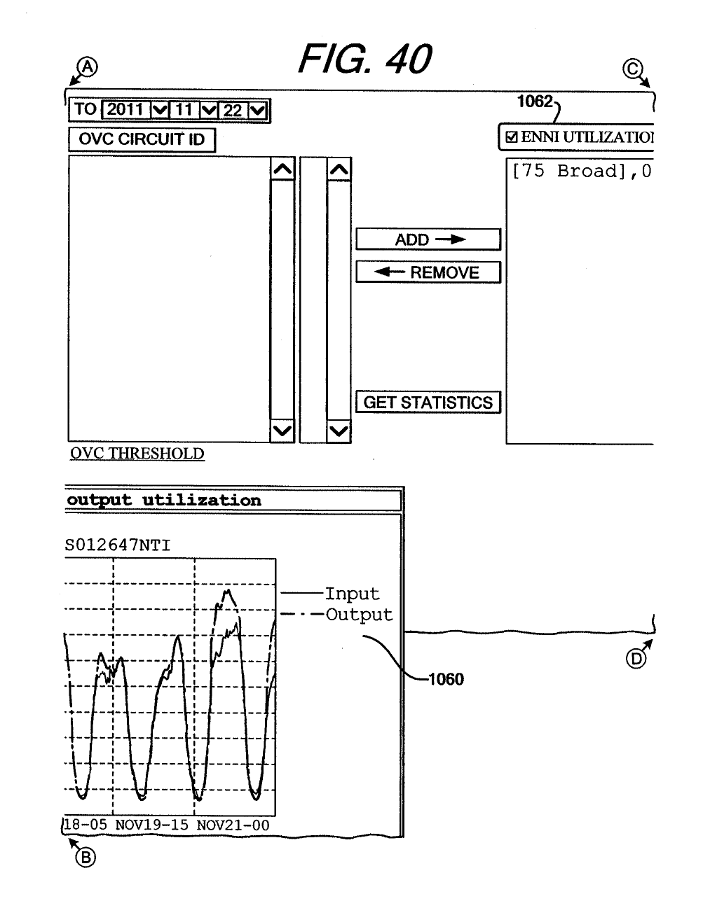

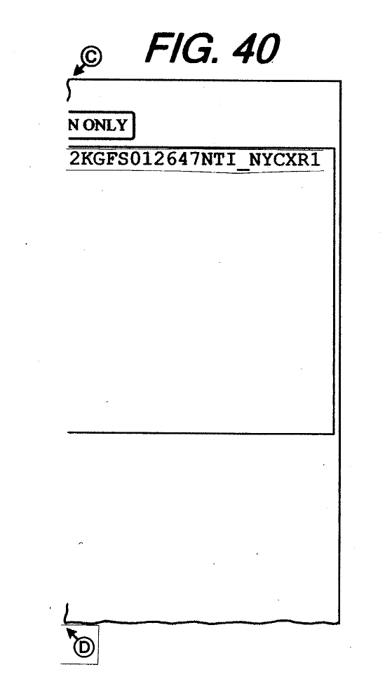

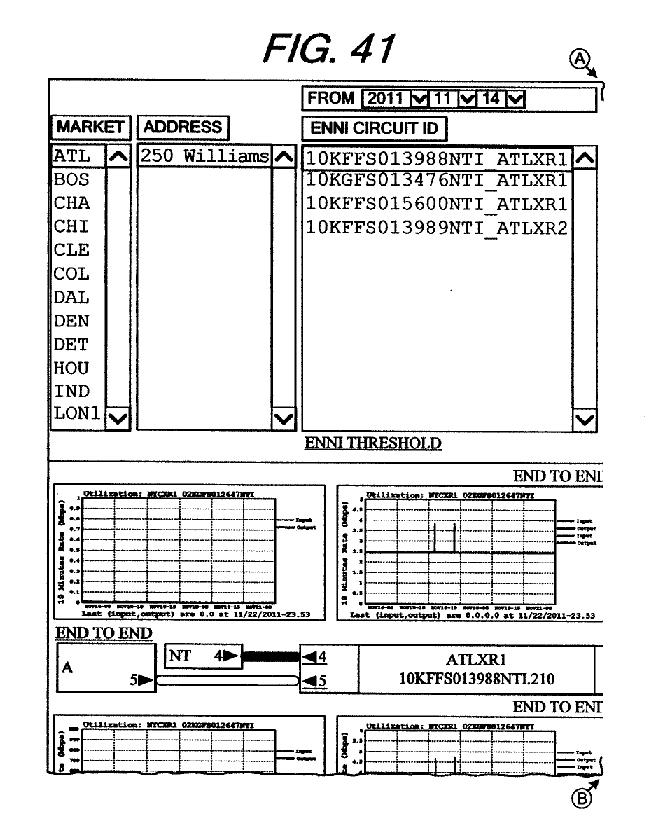

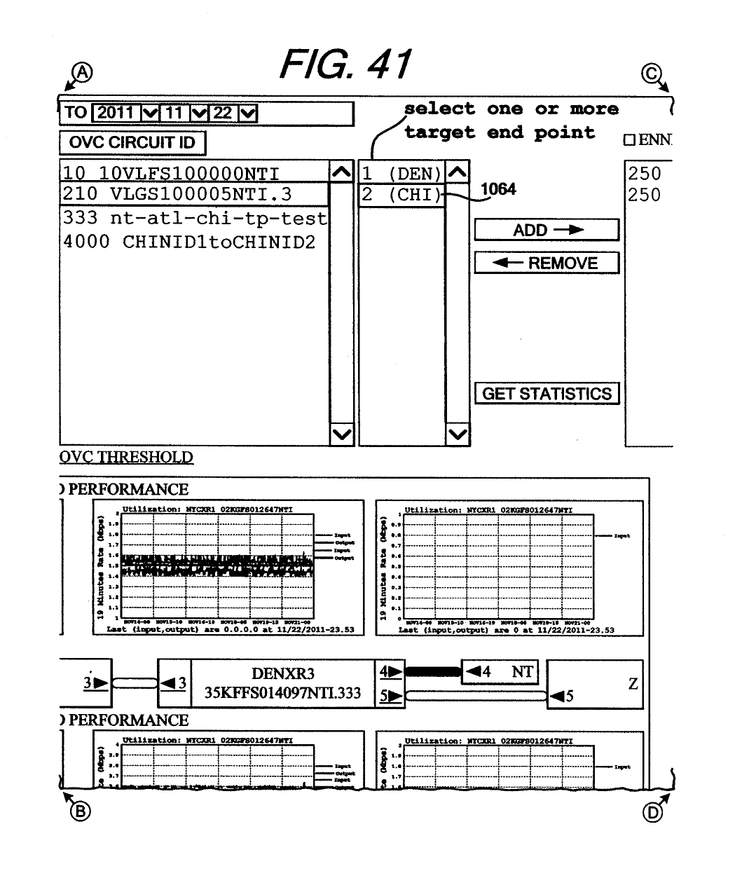

As shown in FIG. 40, the system can also display ENNI (port) aggregate utilization 1060. A user can select this display option by, clicking the “ENNI utilization only check-box” 1062 and selecting the desired ENNI/Port 1010.

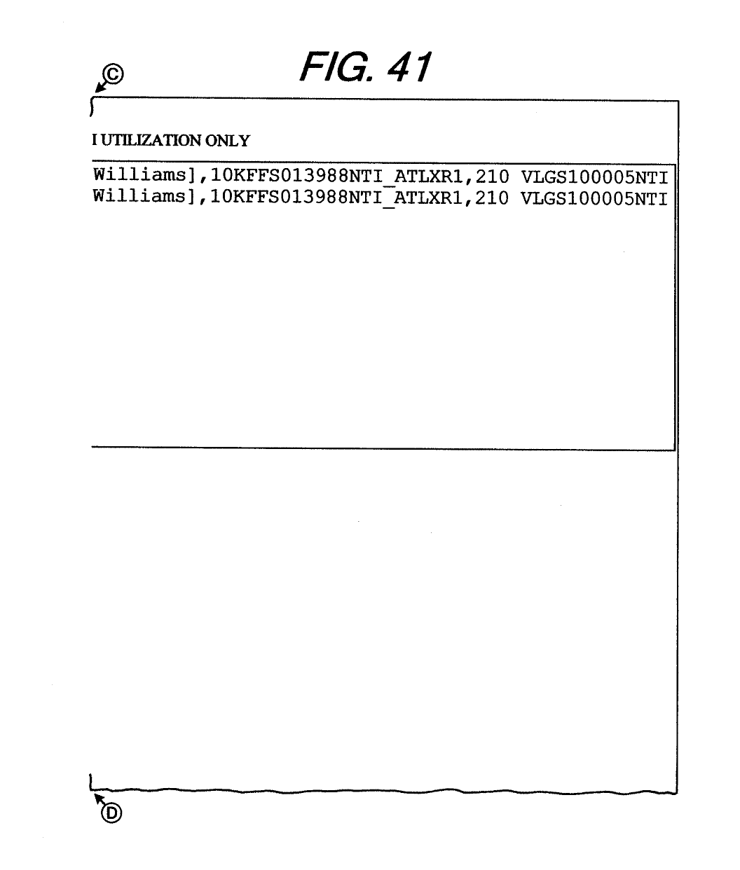

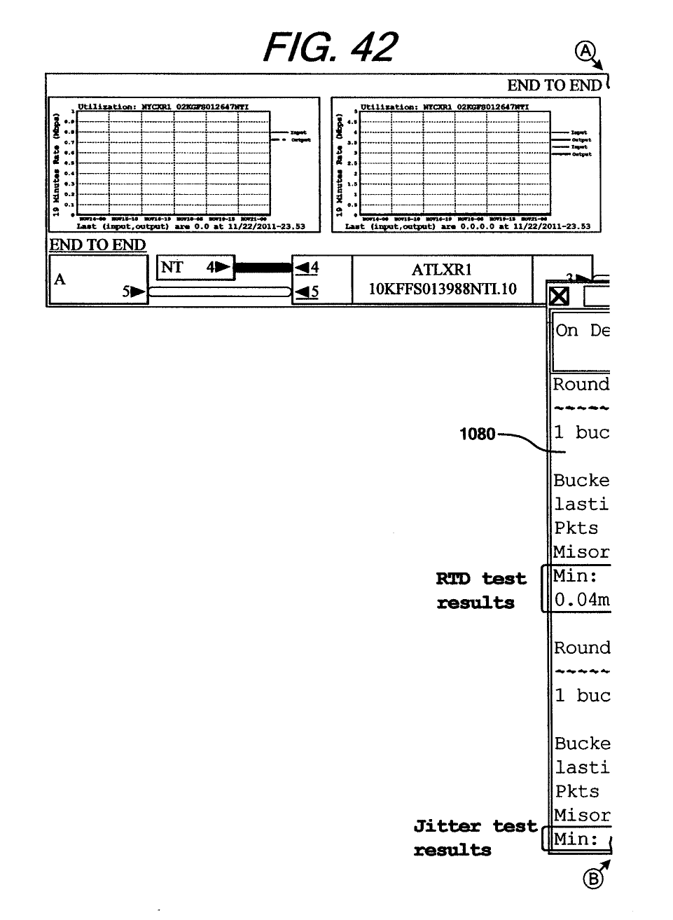

The system also provides for the graphical display of performance statistics for multipoint networks, as shown in FIG. 41. After a user selects a desired market, address, ENNI/port, EVC ID, the user can select one or more target end point(s) 1064.

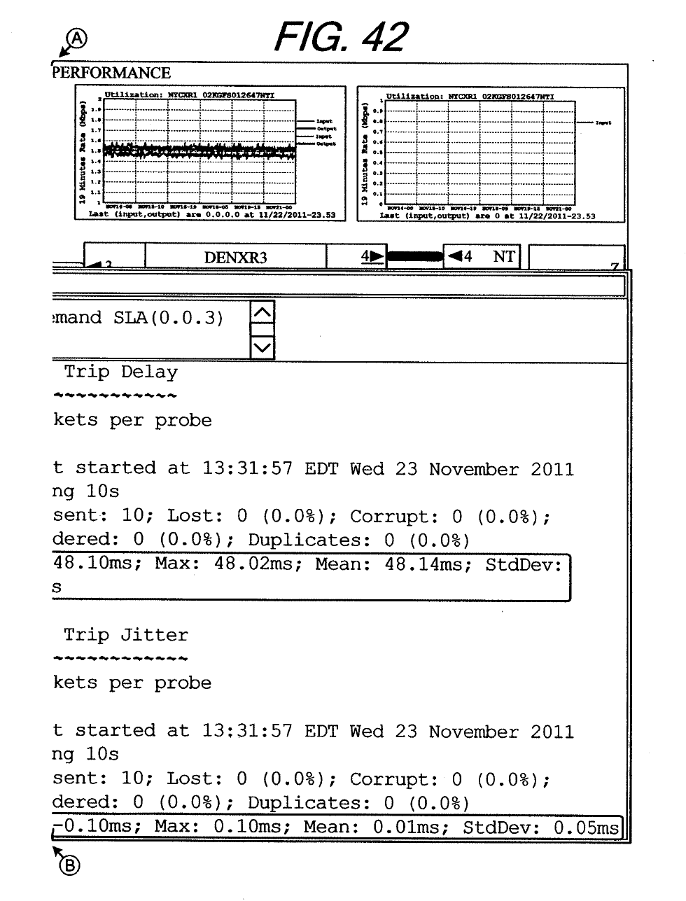

As shown in FIG. 42, the system also provides for on-demand service level monitoring. By clicking on the desired source MEP on the detailed EVC/OVC view, the system provides user the user with a display 1080 of the key performance data including delay, round trip delay and frame loss.

The system also provides for the generation of automatic alerts to notify users when performance indicators surpass or drop below user-defined pre-determined alarm set points. The user can provide the alarm set points for certain data, such as per ENNI/Port Input traffic (Mbps) and per ENNI/Port Output traffic (Mbps). Users can also set alarm set points for Per OVC/EVC Input traffic (Mbps), Output traffic (Mbps), Delay (RID), Jitter and Frame loss, Users can provide one or more addresses, such as email addresses, to which notifications are sent by the system when monitored data exceeds a pre-set alarm point.

While one or more specific embodiments have been illustrated and described in connection with the invention(s), it is understood that the invention(s) should not be limited to any single embodiment, but rather construed in breadth and scope in accordance with later appended claims.

1. A system for diagnostic, performance and fault management of a network, the system comprising:
a central network in communication with a first provider network associated with a first party and comprising a plurality of network elements, and a second provider network associated with a second party and comprising a plurality of network elements, wherein the central network is not associated with the first or second party; and
a server within the central network, the server running an application accessible by a user via a client device, wherein the application allows the user to access, through the central network, and display on the client device, one or more of connectivity data, event data, network element data, and performance data associated with at least a portion of either one or both of the first and second provider networks.

2. The system of claim 1, wherein the application is capable of end-to-end visibility between any two of a plurality of network elements within the first and second provider networks.

3. The system of claim 1, wherein the application allows the user to customize the display of the accessed data.

4. The system of claim 1, wherein the application allows the user to configure a notification of a change in one or more of the connectivity data, event data, network element data, and performance data.

5. The system of claim 4, wherein the notification is an application alert.

6. The system of claim 4, wherein the notification is an electronic communication to a device.

7. The system of claim 1, wherein the application allows the user to select a portion of either one or both of the first and second provider networks for which to access and display data.

8. The system of claim 7, wherein the user selects the portion by selecting a first point within one of the first and second provider networks and a second point within one of the first and second provider networks to define a segment.

9. The system of claim 1, wherein the application allows the user to select at least one of a plurality of domain levels amongst the first and second provider networks for which to display the accessed data.

10. A method for diagnostic, performance and fault management of a network, using a processor of a device within a central network, the method comprising:
receiving a request, at the processor, from a user device to access connectivity data, event data, network element data, or performance data associated with at least a portion of one or both of a first provider network associated with a first party and a second provider network associated with a second party, wherein the central network is not associated with the first or second party;
accessing the requested data, by the processor, in response to the request;
facilitating display of the requested data on the user device, using the processor; and
allowing the user to customize the display of the requested data, using the processor.

11. The method of claim 9, further comprising facilitating selection by the user of a portion of either one or both of the first and second provider networks for which to access and display the requested data, using the processor.

12. The method of claim 9, further comprising facilitating end-to-end visibility to the user between any two of a plurality of network elements within the first and second provider networks, using the processor.

13. The method of claim 9, further comprising facilitating selection by the user of at least one of a plurality of domain levels amongst the first and second provider networks for which to access and display the requested data, using the processor.

14. A computer program product stored on a non-transitory computer-readable medium, the computer program product having computer-executable code instructions which are executable on a computer server to facilitate diagnostic, performance and fault management of a network through a client device, the computer-executable code instructions comprising:
first code instructions for receiving a request from a user device to access connectivity data, event data, network element data, or performance data associated with at least a portion of one or both of a first provider network associated with a first party and a second provider network associated with a second party, wherein the central network is not associated with the first or second party;
second code instructions for accessing the requested data in response to the request;
third code instructions for facilitating display of the requested data on the user device; and
fourth code instructions for allowing the user to customize the display of the requested data.

15. The computer program product of claim 12, the computer-executable code instructions further comprising fifth code instructions for facilitating selection by the user of a portion of either one or both of the first and second provider networks for which to access and display data.

16. The computer program product of claim 12, the computer-executable code instructions further comprising fifth code instructions for facilitating end-to-end visibility to the user between any two of a plurality of network elements within the first and second provider networks.

17. The computer program product of claim 12, the computer-executable code instructions further comprising fifth code instructions for facilitating selection by the user of at least one of a plurality of domain levels amongst the first and second provider networks for which to access and display the requested data.
